(19) United States
(12) Patent Application Publication
(10) Pub. No.: US 2012/0092756 A1
(43) Pub. Date: Apr. 19, 2012

(54) OPTICAL BODY, OPTICAL BODY MANUFACTURING METHOD, WINDOW MEMBER, AND OPTICAL BODY ATTACHING METHOD

(75) Inventors: Hironori Yoshida, Miyagi (JP); Masashi Enomoto, Tokyo (JP); Tsutomu Nagahama, Miyagi (JP); Kimitaka Nishimura, Miyagi (JP); Hayato Hasegawa, Miyagi (JP)

(73) Assignee: SONY CORPORATION, Tokyo (JP)

(21) Appl. No.: 13/033,162

(22) Filed: Feb. 23, 2011

(30) Foreign Application Priority Data
Mar. 2, 2010 (JP) P2010-045779

(51) Int. Cl. G02B 5/122; B23P 17/04; G02B 5/26

(52) U.S. Cl. 359/351; 359/529; 52/741.1; 29/592

(57) ABSTRACT

An optical body including an optical layer having a belt-like or rectangular shape and having an incident surface on which light is incident, and a reflective layer formed in the optical layer and having a corner cube shape, wherein the reflective layer directionally reflects the light incident on the incident surface at an incident angle (θ, φ), and a direction of a ridge of the corner cube shape is substantially parallel to a lengthwise direction of the belt-shaped or rectangular optical layer. θ is an angle formed by a perpendicular line with respect to the incident surface and the incident light incident on the incident surface or reflected light emerging from the incident surface, and φ is an angle formed by the ridge of the corner cube shape and a component resulting from projecting the incident light or the reflected light to the incident surface).

### CROSS REFERENCES TO RELATED APPLICATIONS

The present application claims priority to Japanese Patent Application JP 2010-045779 filed on Mar. 2, 2010, the entire contents of which is hereby incorporated by reference.

### BACKGROUND

The present disclosure relates to an optical body, an optical body manufacturing method, a window member including the optical body, and an optical body attaching method. More particularly, the present invention relates to an optical body that directionally reflects incident light.

Recently, architectural glasses for high-rise buildings, houses, etc. and car window glasses have been designed in an increasing number of cases with the function of partly reflecting sunlight. Such a trend represents one of energy-saving measures with the view of preventing global warming, and it is intended to reduce a load of cooling equipment, which is increased with sunlight energy entering the indoor through windows and raising the indoor temperature.

As examples of techniques for providing the above-described reflection function, there are proposed a technique of coating the window glass with a layer having a high reflectance in a near infrared range, and a technique of coating the window glass with a layer shielding not only infrared, but also visible light at the same time.

As examples of the former technique, various techniques using, as a reflective layer, an optical multilayer film, a metal-containing film, a transparent conductive layer, etc. are already proposed (see, e.g., pamphlet of International Publication WO05/087680). Further, as examples of the latter technique, techniques of forming metallic semitransparent layers are proposed (see, e.g., Japanese Unexamined Patent Application Publication No. 57-59748, No. 57-59749, and No. 2005-343113). However, the reflective layer and the semitransparent layer in the above-mentioned techniques are formed on flat window glasses, and incident sunlight is just specularly (regularly) reflected. Therefore, the light incoming from the sky and specularly reflected by the flat window glasses reaches other outdoor buildings and the ground where the light is absorbed and converted to heat, thus raising the ambient temperature. Accordingly, a local temperature rise occurs in the surroundings of a building in which all windows are coated with the above-mentioned type of reflective layer. This gives rise to the problems that a heat island phenomenon is accelerated in urban areas and grass is not grown only in areas irradiated with the reflected light.

In addition, it has recently been proposed to give outer wall materials for high-rise structure buildings, houses, etc. with the function of reflecting sunlight. However, such a proposal also raises the ambient temperature around the buildings, etc. with the sunlight reflecting function as in the above-described case.

### SUMMARY

It is desirable to provide an optical body which can return light to the sky with high efficiency, a method of manufacturing the optical body, a window member including the optical body, and a method of attaching the optical body.

In an embodiment, an optical body is provided in which a reflective layer has a corner tube shape and directionally reflects light incident on an incident surface at an incident angle (θ, φ) (where θ is an angle formed by a perpendicular line with respect to the incident surface and the incident light incident on the incident surface or reflected light emerging from the incident surface, and φ is an angle formed by a ridge of the corner cube shape and a component resulting from projecting the incident light or the reflected light to the incident surface).

Depending on a direction in which the optical body is attached to a window member, however, a proportion of downward reflection (φ+90° to φ+270°) may be increased when the incident angle (θ, φ) of the light is θ>0°. In other words, the reflection function of the optical body is not effectively developed depending on the attaching direction of the optical body.

In an embodiment, an optical body capable of being easily attached in the direction in which the reflection function of the optical body is provided. In an embodiment, the optical body is formed in a belt-like or rectangular shape, a lengthwise direction of the belt-shaped or rectangular optical body is set substantially parallel to a direction of a ridge of the corner cube, and the optical body is attached to an adherend, such as the window member, with the lengthwise direction of the optical body being substantially parallel to a height direction of a building.

According to one embodiment, there is provided an optical body including an optical layer having a belt-like or rectangular shape and having an incident surface on which light is incident, and a reflective layer formed in the optical layer and having a corner cube shape, wherein the reflective layer directionally reflects the light incident on the incident surface at an incident angle (θ, φ), and a direction of a ridge of the corner cube shape is substantially parallel to a lengthwise direction of the belt-shaped or rectangular optical layer, (θ being an angle formed by a perpendicular line with respect to the incident surface and the incident light incident on the incident surface or reflected light emerging from the incident surface, and φ being an angle formed by the ridge of the corner cube shape and a component resulting from projecting the incident light or the reflected light to the incident surface).

According to another embodiment, there is provided an optical body including an optical layer having a belt-like or rectangular shape and having an incident surface on which light is incident, and a reflective layer formed on the incident surface of the optical layer and having a corner cube shape, wherein the reflective layer directionally reflects the light incident on the incident surface at an incident angle (θ, φ), and a direction of a ridge of the corner cube shape is substantially parallel to a lengthwise direction of the belt-shaped or rectangular optical layer, (θ being an angle formed by a perpendicular line with respect to the incident surface and the incident light incident on the incident surface or reflected light emerging from the incident surface, and φ being an angle formed by the ridge of the corner cube shape and a component resulting from projecting the incident light or the reflected light to the incident surface).

According to another embodiment, there is provided an optical body attaching method including a step of attaching a belt-shaped or rectangular optical body to a window member of a building such that a lengthwise direction of the optical body is substantially parallel to a height direction of the building, the optical body including an optical layer having an incident surface on which light is incident, and a reflective layer formed in the optical layer and having a corner cube shape, wherein the reflective layer directionally reflects the light incident on the incident surface at an incident angle (θ, φ), and a direction of a ridge of the corner cube shape is substantially parallel to the lengthwise direction of the belt-shaped or rectangular optical layer, (θ being an angle formed by a perpendicular line with respect to the incident surface and the incident light incident on the incident surface or reflected light emerging from the incident surface, and φ being an angle formed by the ridge of the corner cube shape and a component resulting from projecting the incident light or the reflected light to the incident surface).

According to another embodiment, there is provided an optical body manufacturing method including the steps of forming a first optical layer having a concave-convex surface in which a plurality of structures having a corner cube shape are formed, forming a reflective layer on the concave-convex surface of the first optical layer, and forming a second optical layer on the reflective layer, the first optical layer and the second optical layer both forming an optical layer having a belt-like or rectangular shape and having an incident surface on which light is incident, wherein the reflective layer directionally reflects the light incident on the incident surface at an incident angle (θ, φ), and a direction of a ridge of the corner cube shape is substantially parallel to a lengthwise direction of the belt-shaped or rectangular optical layer, (θ being an angle formed by a perpendicular line with respect to the incident surface and the incident light incident on the incident surface or reflected light emerging from the incident surface, and φ being an angle formed by the ridge of the corner cube shape and a component resulting from projecting the incident light or the reflected light to the incident surface).

With the embodiments, the light incident on the incident surface at the incident angle (θ, φ) is directionally reflected in a direction other than the direction of specular reflection (−θ, φ+180°). Therefore, the intensity of light reflected in a certain particular direction other than the direction of the specular reflection can be made stronger than the intensity of specularly reflected light and sufficiently stronger than the intensity of light diffusely reflected with no directivity.

With the embodiments, the lengthwise direction of the belt-shaped or rectangular optical body is substantially parallel to the direction of the ridge of the corner cube shape of the optical body. Therefore, the reflection function of the optical body can be effectively developed just by attaching the belt-shaped or rectangular optical body to a window member of a building such that the height direction of the building is substantially parallel to the lengthwise direction of the belt-shaped or rectangular optical body.

According to the embodiments, as described above, the optical body can be easily attached to the building in such a direction that the reflection function of the optical body can be effectively developed. Hence, the reflected light can be efficiently returned to the sky.

Additional features and advantages are described herein, and will be apparent from the following Detailed Description and the figures.

### BRIEF DESCRIPTION OF THE FIGURES

FIG. 1 is a perspective view illustrating an overall appearance of a directional reflector according to a first embodiment;

FIG. 2A is a sectional view illustrating one example of construction of the directional reflector according to the first embodiment, and FIG. 2B is a sectional view illustrating an example in which the directional reflector according to the first embodiment is attached to an adherend (attachment target);

FIG. 3 is a perspective view illustrating the relationship between incident light that is incident on the directional reflector and reflected light that is reflected by the directional reflector;

FIG. 4A is a plan view illustrating one example of the shape of a concave-convex surface of a first optical layer, and FIG. 4B is a sectional view of the first optical layer taken along line IVB-IVB in FIG. 4A;

FIG. 5 is an enlarged plan view illustrating, in an enlarged scale, part of the concave-convex surface of the first optical layer illustrated in FIG. 4A;

FIGS. 6A and 6B are each a sectional view to explain one example of functions of the directional reflector;

FIG. 7A is a perspective view illustrating an overall appearance of a roll-shaped master, FIG. 7B is an enlarged plan view illustrating, in an enlarged scale, a region R illustrated in FIG. 7A, and FIG. 7C is a sectional view taken along line VIIC-VIIC in FIG. 7B;

FIG. 8 is a perspective view illustrating one example of construction of a machining apparatus for fabricating the roll-shaped master;

FIG. 9A is a perspective view illustrating an overall appearance of a workpiece, and FIG. 9B is a development view of the workpiece illustrated in FIG. 9A;

FIG. 10 is a diagram illustrating machining directions for V-shaped grooves;

FIGS. 11A to 11C illustrate successive steps to explain one example of a workpiece machining method according to the first embodiment;

FIG. 12 is a schematic view illustrating one example of construction of a forming apparatus for forming the first optical layer;

FIG. 13 is a schematic view illustrating one example of construction of a manufacturing apparatus for manufacturing the directional reflector according to the first embodiment;

FIGS. 14A to 14C illustrate successive steps to explain one example of a method of manufacturing the directional reflector according to the first embodiment;

FIGS. 15A to 15C illustrate successive steps to explain one example of the method of manufacturing the directional reflector according to the first embodiment;

FIGS. 16A to 16C illustrate successive steps to explain one example of the method of manufacturing the directional reflector according to the first embodiment;

FIGS. 17A and 17B are illustrations to explain one example of a method of attaching the directional reflector according to the first embodiment;

FIGS. 18A and 18B are illustrations to explain the difference in reflection function of the directional reflector depending on the attaching direction;

FIG. 19A is a sectional view illustrating a first modification of the first embodiment, and FIG. 19B is a sectional view illustrating a second modification of the first embodiment;

FIG. 20A is a plan view illustrating one example of the shape of a concave-convex surface of a first optical layer, and FIG. 20B is a sectional view of the first optical layer taken along line XXB-XXB in FIG. 20A;

FIG. 21 is an enlarged plan view illustrating, in an enlarged scale, part of the concave-convex surface of the first optical layer illustrated in FIG. 20A;

FIG. 22A is a perspective view illustrating an overall appearance of a workpiece, and FIG. 22B is a development view of the workpiece illustrated in FIG. 22A;

FIGS. 23A and 23B are illustrations to explain one example of a method of attaching a directional reflector according to a second embodiment;

FIG. 24A is a sectional view illustrating a first example of construction of the directional reflector according to a third embodiment, FIG. 24B is a sectional view illustrating a second example of construction of the directional reflector according to the third embodiment, and FIG. 24C is a sectional view illustrating a third example of construction of the directional reflector according to the third embodiment;

FIG. 25 is a sectional view illustrating one example of construction of a directional reflector according to a fourth embodiment;

FIG. 26 is a sectional view illustrating one example of construction of a directional reflector according to a fifth embodiment;

FIG. 27A is a sectional view illustrating one example of construction of a directional reflector according to a sixth embodiment, and FIG. 27B is a sectional view illustrating an example in which the directional reflector according to the sixth embodiment is attached to and adherend;

FIG. 28 is a perspective view illustrating one example of construction of a blind device according to a seventh embodiment;

FIG. 29A is a sectional view illustrating a first example of construction of a slat, FIG. 29B is a sectional view illustrating a second example of construction of the slat, and FIG. 29C is a plan view of the slat, looking from the side including the incident surface on which outside light is incident, when a slat group is in a closed state;

FIG. 30A is a perspective view illustrating one example of construction of a rolling screen device according to an eighth embodiment, and FIG. 30B is a sectional view, taken along line XXXB-XXXB in FIG. 30A, illustrating one example of construction of a screen;

FIG. 31A is a perspective view illustrating one example of construction of a fitting according to a ninth embodiment, and FIG. 31B is a sectional view illustrating one example of construction of an optical body;

FIG. 32 is a schematic view illustrating one example of construction of a machining apparatus according to a tenth embodiment;

FIG. 33 is an illustration to explain simulation conditions in TEST EXAMPLE 1;

FIG. 34 is a graph plotting upward reflectance obtained with the simulation in TEST EXAMPLE 1;

FIG. 35 is an illustration to explain simulation conditions in TEST EXAMPLE 2;

FIG. 36 is a graph plotting upward reflectance obtained with the simulations in TEST EXAMPLES 2 to 4; and

FIG. 37 is an illustration to explain one example of construction of a system for measuring the upper reflectance.

### DETAILED DESCRIPTION

Embodiments will be described in the sequence listed below with reference to the drawings.

1. First embodiment (representing an example of a directional reflector having a belt-like or rectangular shape

2. Second embodiment (representing an example in which a widthwise direction of the directional reflector and a ridge direction of a corner cube patter are substantially parallel to each other)

3. Third embodiment (representing an example in which the directional reflector includes a light scatterer)

4. Fourth embodiment (representing an example of the directional reflector in which a reflective layer is directly formed on the surface of a window member)

5. Fifth embodiment (representing an example in which a self-cleaning effect layer is formed on an exposed surface of the directional reflector)

6. Sixth embodiment (representing an example in which the reflective surface is exposed)

7. Seventh embodiment (representing an example in which the directional reflector is applied to a blind device)

8. Eighth embodiment (representing an example in which the directional reflector is applied to a rolling screen device)

9. Ninth embodiment (representing an example in which the directional reflector is applied to a fitting)

10. Tenth embodiment (representing an example in which grooves are formed by using two bites)

### 1. First Embodiment

[Construction of Directional Reflector]

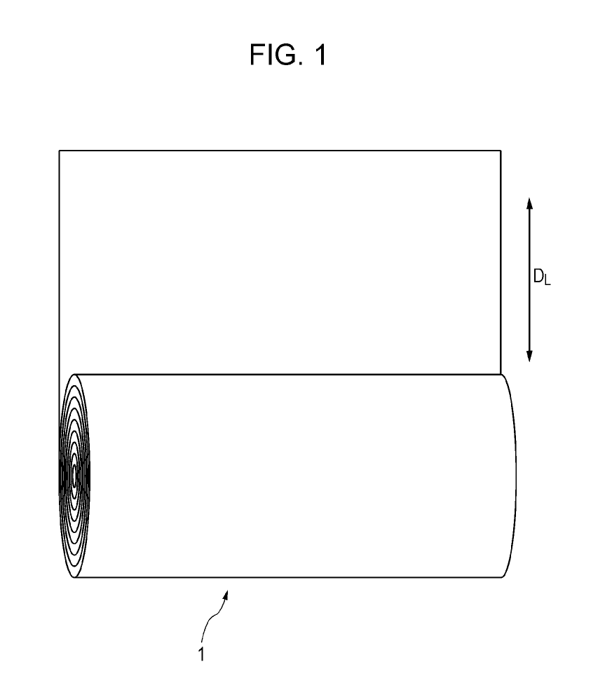

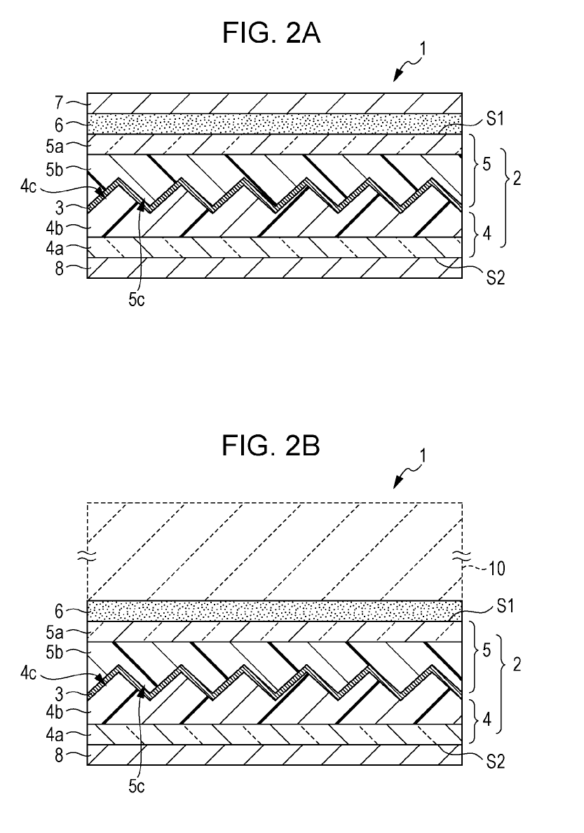

FIG. 1 is a perspective view illustrating an overall appearance of a directional reflector according to a first embodiment. FIG. 2A is a sectional view illustrating one example of construction of the directional reflector according to the first embodiment. FIG. 2B is a sectional view illustrating an example in which the directional reflector according to the first embodiment is attached to an adherend (attachment target). As illustrated in FIG. 1, the directional reflector 1 has a belt-like shape and is wound into a roll-like form to provide the so-called stock roll. In the following description, a lengthwise direction (i.e., direction of length) of the belt-shaped directional reflector 1 is called a “lengthwise direction D_{L}”.

As illustrated in FIG. 2A, the directional reflector 1 includes an optical layer 2 having a belt-like shape, and a reflective layer 3 formed in the optical layer 2 and having a corner cube shape, for example. The optical layer 2 includes a first optical layer 4 having a concave-convex surface, and a second optical layer 5 having a concave-convex surface. The concave-convex surfaces of the first optical layer 4 and the second optical layer 5 are in close contact with each other with, e.g., the reflective layer 3 interposed therebetween. The directional reflector 1 has an incident surface 51 on which light, such as sunlight, is incident, and an emergent surface S2 from which, of the light incident on the incident surface 51, part having passed through the directional reflector 1 emerges. The directional reflector 1 is suitably applied to inner wall members, outer wall members, window members, wall materials, and so on. Further, the directional reflector 1 is suitably applied to a slat (one example of a solar shading member) of a blind device and a screen (another example of the solar shading member) of a rolling screen device. Moreover, the directional reflector 1 is suitably employed as an optical body that is disposed in a lighting portion of a fitting (i.e., an internal member or an external member), such as a shoji (i.e., a paper-made and/or glass-fitted sliding door).

The directional reflector 1 may further include an attaching layer 6, if necessary. The attaching layer 6 is formed on one of the incident surface S1 and the emergent surface S2 of the directional reflector 1, which is to be attached to a window member 10. Thus, the directional reflector 1 is attached to the indoor or outdoor side of the window member 10, i.e., the adherend, with the attaching layer 6 interposed therebetween. The attaching layer 6 can be formed, for example, as a bonding layer containing a bond (e.g., a UV-cured resin or a two-liquid mixed resin) as a main component, or as an adhesive layer containing an adhesive (e.g., a PSA (Pressure Sensitive Adhesive)) as a main component. When the attaching layer 6 is the adhesive layer, a peeling-off layer 7 is preferably further formed on the attaching layer 6. With the provision of the peeling-off layer 7, the directional reflector 1 can be easily attached to the adherend, e.g., the window member 10, with the attaching layer 6 interposed therebetween just by peeling the peeling-off layer 7, as illustrated in FIG. 2B.

From the viewpoint of increasing adhesion between the directional reflector 1 and the attaching layer 6, the directional reflector 1 may further include a primer layer (not shown) between the directional reflector 1 and the attaching layer 6. Also, from the viewpoint of increasing adhesion between the directional reflector 1 and the attaching layer 6, ordinary physical pretreatment is preferably performed on the incident surface S1 or the emergent surface S2 on which the attaching layer 6 of the directional reflector 1 is to be formed. Examples of the ordinary physical pretreatment include plasma treatment and corona treatment.

The directional reflector 1 may further include a barrier layer (not shown) on the incident surface S1 or the emergent surface S2 which is attached to the adherend, e.g., the window member 10, or between the surface S1 or S2 and the reflective layer 3. With the provision of the barrier layer, it is possible to reduce diffusion of moisture into the reflective layer 3 from the incident surface S1 or the emergent surface S2 and to suppress deterioration of a metal, etc. contained in the reflective layer 3. Accordingly, durability of the directional reflector 1 can be improved.

In addition, the directional reflector 1 may include a hard coat layer 8 from the viewpoint of giving the surface of the directional reflector 1 with resistance against scratching. The hard coat layer 8 is preferably formed on one of the incident surface S1 and the emergent surface S2 of the directional reflector 1, which is positioned on the opposite side to the surface attached to the adherend, e.g., the window member 10. A water-repellent or hydrophilic layer may be further formed on the incident surface S1 of the directional reflector 1 from the viewpoint of providing, e.g., an antifouling property. The layer having such a function may be formed, for example, directly on the optical layer 2 or on one of various functional layers such as the hard coat layer 8.

The directional reflector 1 preferably has flexibility from the viewpoint of enabling the directional reflector 1 to be easily attached to the adherend, e.g., the window member 10. Moreover, the directional reflector 1 is preferably an optical film having flexibility. Such a property enables the belt-shaped directional reflector 1 to be wound into the stock roll, thus improving easiness in, for example, carrying and handling the directional reflector 1. Herein, the term “film” is construed as including a sheet. The form of the directional reflector 1 is not limited to a film and may be a plate or a block.

The directional reflector 1 has transparency. A degree of the transparency preferably satisfies a later-described range of transmission image clarity. The difference in refractive index between the first optical layer 4 and the second optical layer 5 is preferably 0.010 or less, more preferably 0.008 or less, and even more preferably 0.005 or less. If the difference in refractive index exceeds 0.010, a transmission image tends to blur in appearance. When the difference in refractive index is more than 0.008 and not more than 0.010, there are no problems in daily life though depending on outdoor brightness. When the difference in refractive index is more than 0.005 and not more than 0.008, the outdoor sight can be clearly viewed although only a very bright object, such as a light source, causes a displeasing diffraction pattern. When the difference in refractive index is 0.005 or less, the diffraction pattern is hardly displeasing. One of the first optical layer 4 and the second optical layer 5 on the side attached to, e.g., the window member 10 may contain an adhesive as a main component. With such a feature, the directional reflector 1 can be attached to, e.g., the window member 10 by using the first optical layer 4 or the second optical layer 5 that contains the adhesive as the main component. In that case, the difference in refractive index with respect to the adhesive is preferably within the above-described range.

The first optical layer 4 and the second optical layer 5 preferably have the same optical characteristics, such as the refractive index. More specifically, the first optical layer 4 and the second optical layer 5 are preferably made of the same material, e.g., the same resin material, having transparency in the visible range. By using the same material to form the first optical layer 4 and the second optical layer 5, the refractive indexes of both the optical layers are equal to each other, and hence transparency to visible light can be improved. However, even when the starting material is the same, care is to be paid to such a point that the refractive indexes of finally formed layers may differ from each other depending on, e.g., curing conditions in a film forming process. On the other hand, when the first optical layer 4 and the second optical layer 5 are made of different materials, a transmission image tends to blur for the reason that light is refracted at the reflective layer 3, which serves as a boundary, due to the difference in refractive index between both the optical layers. In particular, there is a tendency that when observing an object analogous to a point light source, such as a lamp at a far distance, a diffraction pattern is conspicuously observed.

The first optical layer 4 and the second optical layer 5 preferably have transparency in the visible range. Herein, the term “transparency” is defined as having two meanings, i.e., as neither absorbing light nor scattering light. When the term “transparency” is generally used, it often implies the former meaning. In the directional reflector 1 according to the first embodiment, however, it preferably has the transparency in both the meanings A currently employed retroreflector is intended to visually confirm light reflected from road signs, clothes of night workers, etc. to provide a noticeable indication. Therefore, even when the retroreflector has a scattering property, light reflected from an underlying reflector can be visually observed if the retroreflector is in close contact with the underlying reflector. Such a phenomenon is based on the same principle as that an image can be visually confirmed even when antiglare treatment providing a scattering property is applied to a front surface of an image display for the purpose of imparting resistance against glare. In contrast, the directional reflector 1 according to the first embodiment preferably does not scatter light for the reason that the directional reflector is featured in transmitting light other than light directionally reflected at specific wavelengths, and it is attached to a transmission body transmitting primarily light of transmission wavelengths, thus allowing the transmitted light to be observed. Depending on usage, however, the second optical layer 5 may be intentionally provided with the scattering property.

The directional reflector 1 is preferably used in such a way that it is attached to a rigid member, e.g., the window member 10, having transmissivity primarily to the light other than the light directionally reflected at the specific wavelengths, with, e.g., an adhesive interposed therebetween. Examples of the window member 10 include architectural window members for high-rise buildings, houses, etc. and window members for vehicles. When the directional reflector 1 is applied to architectural window members, the directional reflector 1 is preferably applied to the window member 10 that is oriented to face, particularly, in some direction in a range from east to south and further to west (e.g., some direction in a range from southeast to southwest). This is because, by applying the directional reflector 1 to the window member 10 to be oriented as mentioned above, heat rays can be more effectively reflected. The directional reflector 1 can be applied to not only a single-layer window glass, but also a special glass, such as multilayer glass. Further, the window member 10 is not limited to a glass-made member and it may be a member made of a high-molecular material having transparency. The optical layer 2 preferably has transparency in the visible range. The reason is that, with the optical layer 2 having transparency in the visible range, when the directional reflector 1 is attached to the window member 10, e.g., the window glass, visible light is allowed to pass through the directional reflector 1 and lighting based on sunlight can be ensured. The directional reflector 1 may be attached to not only an inner surface of a glass pane, but also an outer surface thereof.

Further, the directional reflector 1 can be used in combination with another heat-ray cutting film. For example, a light absorption coating may be disposed at the interface between air and the optical layer 2. Still further, the directional reflector 1 can be used in combination with a hard coat layer, an ultraviolet cutting layer, a surface antireflective layer, etc. When one or more of those functional layers are used in a combined manner, the functional layer is preferably disposed at the interface between the directional reflector 1 and air. However, the ultraviolet cutting layer is to be disposed on the side closer to the sun than the directional reflector 1. Thus, particularly when the directional reflector 1 is attached to an inner surface of the window glass having surfaces to face the inside and the outside of a room, the ultraviolet cutting layer is desirably disposed between the inner surface of the window glass and the directional reflector 1. In that case, an ultraviolet absorber may be pasted to be mixed in an attaching layer between the inner surface of the window glass and the directional reflector 1.

Depending on usage of the directional reflector 1, the directional reflector 1 may be colored to have a visually attractive design. When the visually attractive design is given to the directional reflector 1, at least one of the first optical layer 4 and the second optical layer 5 is preferably formed to absorb primarily light in a particular wavelength band within the visible range to such an extent as not reducing transparency.

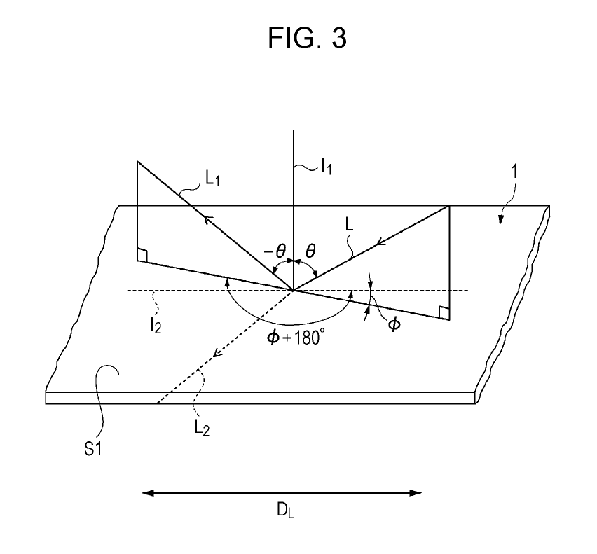

FIG. 3 is a perspective view illustrating the relationship between incident light that is incident on the directional reflector 1 and reflected light that is reflected by the directional reflector 1. The directional reflector 1 has the incident surface 51 on which light L is incident. When the reflective layer 3 is a wavelength-selective reflective layer, it is preferable that, of the light L incident on the incident surface 51 at an incident angle (θ, φ), the direction reflector 1 selectively directionally reflects light L₁ in a specific wavelength band in a direction other than a specular reflection direction (−θ, φ+180°) while transmitting light L₂ in wavelength bands other than the specific wavelength band. Also, the directional reflector 1 has transparency to the light in the wavelength bands other than the specific wavelength band. The transparency preferably falls within the later-described range of transmission image clarity. When the reflective layer 3 is a semitransparent layer, it is preferable that the directional reflector 1 selectively directionally reflects, of the light L incident on the incident surface S1 at the incident angle (θ, φ), part L₁ thereof in a direction other than the specular reflection direction (−θ, φ+180°) while transmitting the remaining light L₂. Herein, θ is an angle formed by a perpendicular line l₁ with respect to the incident surface S1 and the incident light L or the reflected light L₁. Also, φ is an angle formed by a specific linear line l₂ in the incident surface S1 and a component resulting from projecting the incident light L or the reflected light L₁ to the incident surface S1. The specific linear line l₂ in the incident surface S1 implies an axis in which the reflection intensity is maximized in the direction φ when the directional reflector 1 is rotated about an axis provided by the perpendicular line l₁ with respect to the incident surface S1 of the directional reflector 1 while the incident angle (θ, φ) is held fixed. When there are plural axes (directions) in which the reflection intensity is maximized, one of the axes is selected as the linear line L₂. Further, an angle θ rotated clockwise from the perpendicular line l₁ as a reference is defined as “+θ”, and an angle θ rotated counterclockwise from the perpendicular line l₁ is defined as “−θ”. An angle φ rotated clockwise from the linear line l₂ as a reference is defined as “+φ”, and an angle φ rotated counterclockwise from the linear line l₂ is defined as “−φ”. When the reflective layer 3 is semitransparent layer, the directionally reflected light is preferably light primarily falling in a wavelength band from 400 nm or longer to 2100 nm or shorter.

A direction of the specific linear line l₂ in the incident surface S1 is substantially parallel to the lengthwise direction of the directional reflector 1 having the belt-like shape. Herein, the expression “substantially parallel” implies that an angle formed between the specific linear line l₂ in the incident surface S1 and the lengthwise direction of the directional reflector 1 is ±10° or smaller, including the case where they are exactly parallel to each other and hence the angle formed therebetween is 0°.

The light in the specific wavelength band, which is to be selectively directionally reflected, and the particular light to be transmitted are set different from each other depending on the usage of the directional reflector 1. For example, when the directional reflector 1 is applied to the window member 10, the light in the specific wavelength band, which is to be selectively directionally reflected, is preferably near infrared light and the light in the other wavelength bands to be transmitted is preferably visible light. In more detail, the light in the specific wavelength band, which is to be selectively directionally reflected, is preferably near infrared light primarily falling in a wavelength band of 780 nm to 2100 nm. By selecting the near infrared light, a temperature rise in a building can be suppressed when the directional reflector 1 is attached to the window member 10 such as the window glass. Accordingly, a cooling load can be reduced and energy saving can be achieved. Herein, the expression “directionally reflected” implies that light is reflected in a particular direction other than the specular reflection direction and the intensity of the reflected light is sufficiently stronger than the intensity of light diffusely reflected with no directivity. Further, the expression “reflected” implies that the reflectance in a specific wavelength band, e.g., in the near infrared range, is preferably 30% or more, more preferably 50% or more, and even more preferably 80% or more. The expression “transmitted” implies that the transmittance in a specific wavelength band, e.g., in the visible range, is preferably 30% or more, more preferably 50% or more, and even more preferably 70% or more.

A direction φₒ in which the incident light is directionally reflected is preferably in the range of −90° to 90°. The reason is that when the directional reflector 1 is attached to the window member 10, it can return, of the light incoming from the sky, the light in the specific wavelength band toward the sky. When there are no high-rise buildings in the surroundings, the directional reflector 1 directionally reflecting the incident light in the above-mentioned range is usefully employed. Further, the direction of the directional reflection is preferably in the vicinity of (θ, −φ). The expression “vicinity” implies that a deviation in the direction of the directional reflection is preferably within 5 degrees, more preferably within 3 degrees, and even more preferably within 2 degrees with respect to (θ, −φ). The reason is that, by setting the direction of the directional reflection of the light in the specific wavelength band as described above, when the directional reflector 1 is attached to the window member 10, it can efficiently return, of the light incoming from the sky above buildings standing side by side at substantially the same height, the light in the specific wavelength band toward the sky above the adjacent buildings. To realize such directional reflection, it is preferable, for example, to employ a three-dimensional structure that is formed by using not only a part of a spherical surface or a hyperbolic surface, but also a triangular pyramid, a quadrangular pyramid, or a circular cone. The light incoming in the direction (θ, φ) (−90°<φ<90°) can be reflected in a direction (θₒ, φₒ) (0°<θₒ<90° and −90°<φₒ<90°) in accordance with the shape of the three-dimensional structure.

The light in the specific wavelength band is preferably directionally reflected in a direction in the vicinity of the direction of retroreflection. In other words, of the light incident on the incident surface S1 at the incident angle (θ, φ), the direction of the reflection of the light in the specific wavelength band is preferably in the vicinity of (θ, φ). The reason is that when the directional reflector 1 is attached to the window member 10, it can return, of the light incoming from the sky, the light in the specific wavelength band toward the sky. Herein, the expression “vicinity” implies that a deviation in the direction of the directional reflection is preferably within 5 degrees, more preferably within 3 degrees, and even more preferably within 2 degrees. The reason is that, by setting the direction of the directional reflection of the light in the specific wavelength band as described above, when the directional reflector 1 is attached to the window member 10, it can efficiently return, of the light incoming from the sky, the light in the specific wavelength band toward the sky. In the case of, e.g., an infrared sensor or an infrared image pickup device where an infrared irradiation unit and a light receiving unit are arranged adjacent to each other, the direction of retroreflection is to be set aligned with the incident direction. However, when sensing in a specific direction is not performed as in the embodiments, the direction of retroreflection and the incident direction may be set not so exactly aligned with each other.

When the reflective layer 3 is the wavelength-selective reflective layer, a value of the transmission image clarity in the transmission wavelength band is preferably 50 or larger, more preferably 60 or larger, and even more preferably 75 or larger when an optical comb of 0.5 mm is used. If the value of the transmission image clarity is smaller than 50, a transmission image tends to blur in appearance. When the value of the transmission image clarity is not smaller than 50 and smaller than 60, there are no problems in daily life though depending on outdoor brightness. When the value of the transmission image clarity is not smaller than 60 and smaller than 75, the outdoor sight can be clearly viewed although only a very bright object, such as a light source, causes a displeasing diffraction pattern. When the value of the transmission image clarity is not smaller than 75, the diffraction pattern is hardly displeasing. Further, a total of values of the transmission image clarity measured using optical combs of 0.125 mm, 0.5 mm, 1.0 mm and 2.0 mm is preferably 230 or larger, more preferably 270 or larger, and even more preferably 350 or larger. If the total value of the transmission image clarity is smaller than 230, a transmission image tends to blur in appearance. When the total value of the transmission image clarity is not smaller than 230 and smaller than 270, there are no problems in daily life though depending on outdoor brightness. When the total value of the transmission image clarity is not smaller than 270 and smaller than 350, the outdoor sight can be clearly viewed although only a very bright object, such as a light source, causes a displeasing diffraction pattern. When the total value of the transmission image clarity is not smaller than 350, the diffraction pattern is hardly displeasing. Herein, the value of the transmission image clarity is measured in conformity with JIS K7105 by using ICM-1T made by Suga Test Instruments Co., Ltd. When the wavelength to be transmitted differs from that of a D65 light source, the measurement is preferably performed after calibration by using a filter having the wavelength to be transmitted.

When the reflective layer 3 is a semitransparent layer, a value of the transmission image clarity measured for the D65 light source is preferably 30 or larger, more preferably 50 or larger, and even more preferably 75 or larger when the optical comb of 0.5 mm is used. If the value of the transmission image clarity is smaller than 30, a transmission image tends to blur in appearance. When the value of the transmission image clarity is not smaller than 30 and smaller than 50, there are no problems in daily life though depending on outdoor brightness. When the value of the transmission image clarity is not smaller than 50 and smaller than 75, the outdoor sight can be clearly viewed although only a very bright object, such as a light source, causes a displeasing diffraction pattern. When the value of the transmission image clarity is not smaller than 75, the diffraction pattern is hardly displeasing. Further, a total of values of the transmission image clarity measured using the optical combs of 0.125 mm, 0.5 mm, 1.0 mm and 2.0 mm is preferably 170 or larger, more preferably 230 or larger, and even more preferably 350 or larger. If the total value of the transmission image clarity is smaller than 170, a transmission image tends to blur in appearance. When the total value of the transmission image clarity is not smaller than 170 and smaller than 230, there are no problems in daily life though depending on outdoor brightness. When the total value of the transmission image clarity is not smaller than 230 and smaller than 350, the outdoor sight can be clearly viewed although only a very bright object, such as a light source, causes a displeasing diffraction pattern. When the total value of the transmission image clarity is not smaller than 350, the diffraction pattern is hardly displeasing. Herein, the value of the transmission image clarity is measured in conformity with JIS K7105 by using ICM-1T made by Suga Test Instruments Co., Ltd.

Haze occurred in the transmission wavelength band is preferably 6% or less, more preferably 4% or less, and even more preferably 2% or less. The reason is that if the haze exceeds 6%, the transmitted light is scattered and a view is obscured. Herein, the haze is measured in accordance with the measurement method stipulated in JIS K7136 by using HM-150 made by Murakami Color Research Laboratory Co., Ltd. When the wavelength to be transmitted differs from that of the D65 light source, the measurement is preferably performed after calibration using a filter having the wavelength to be transmitted. The incident surface S1, preferably both the incident surface S1 and the emergent surface S2, of the directional reflector 1 have smoothness at such a level as not degrading the transmission image clarity. More specifically, arithmetic mean roughness Ra of the incident surface S1 and the emergent surface S2 is preferably 0.08 μm or less, more preferably 0.06 μm or less, and even more preferably 0.04 μm or less. Note that the arithmetic mean roughness Ra is obtained as a roughness parameter by measuring the surface roughness of the incident surface S1 and deriving a roughness curve from a two-dimensional profile curve. Measurement conditions are in conformity with JIS B0601:2001. Details of a measurement apparatus and the measurement conditions are as follows:

Measurement apparatus: full-automated fine shape measuring machine SURFCODER ET4000A (made by Kosaka Laboratory Ltd.)

λc=0.8 mm, evaluation length of 4 mm, cutoff×5, and

Data sampling interval of 0.5 μm

The transmitted light through the directional reflector 1 is preferably as close as possible to neutral in color. Even when the transmitted light is colored, the color preferably has a light tone in blue, blue-green, or green, for example, which provides a cool feeling. From the viewpoint of obtaining such a color tone, chromaticity coordinates x and y of the reflected light and the transmitted light, output from the emergent surface S2 after entering the incident surface S1 and passing through both the optical layer 2 and the reflective layer 3, satisfy respective ranges of preferably 0.20<x<0.35 and 0.20<y<0.40, more preferably 0.25<x<0.32 and 0.25<y<0.37, and even more preferably 0.30<x<0.32 and 0.30<y<0.35, when measured for irradiation using the D65 light source, for example. Further, from the viewpoint of avoiding the color tone from becoming reddish, the chromaticity coordinates x and y satisfy the relationships of preferably y>x−0.02 and more preferably y>x. In addition, change of the reflected color tone depending on the incident angle is undesired because, when the directional reflector is applied to, e.g., building windows, the color tone is different depending on a viewing place and an appearing color is changed upon walking From the viewpoint of suppressing the above-mentioned changes in the color tone, the light preferably enters the incident surface S1 or the emergent surface S2 at the incident angle θ of 5° or larger and 60° or smaller, and each of an absolute value of difference between chromaticity coordinates x and an absolute value of difference between chromaticity coordinates y of the specular reflection lights reflected by the optical layer 2 and the reflective layer 3 is preferably 0.05 or smaller, more preferably 0.03 or smaller, and even more preferably 0.01 or smaller at each of both the principal surfaces of the directional reflector 1. The above-described limitations on numerical ranges regarding the chromaticity coordinates x and y of the reflected light are desirably satisfied for both of the incident surface S1 and the emergent surface S2.

To suppress color change in the vicinity of the specular reflection, it is desirable that the directional reflector 1 doe not include a flat surface having a slope angle of preferably 5° or smaller and more preferably 10° or smaller. When the reflective layer 3 is covered with a resin, the incident light is refracted upon entering the resin from air, and hence the color tone change in the vicinity of the specular reflection can be suppressed in a wider range of incident angle. Additionally, when the color of light reflected in other directions than the specular reflection direction is to be taken into consideration, the optical film (directional reflector) 1 is preferably arranged such that the directionally reflected light is not advanced in the relevant direction.

The first optical layer 4, the second optical layer 5, and the reflective layer 3, which constitute the directional reflector 1, will be described below in sequence.

(First Optical Layer)

The first optical layer 4 is, for example, a support for supporting the reflective layer 3. Further, the first optical layer 4 serves to not only improve the transmission image clarity and the total light transmittance, but also protect the reflective layer 3. The first optical layer 4 is preferably in the form of a film from the viewpoint of giving the directional reflector 1 with flexibility, but the form of the first optical layer 4 is not limited to particular one. Preferably, one of two principal surfaces of the first optical layer 4 is a smooth surface and the other is concave-convex surface.

The concave-convex surface of the first optical layer 4 is formed, for example, by a plurality of two-dimensionally arranged structures 4c. A pitch P of the structures 4c is preferably not smaller than 5 μm and not larger than 5 mm, preferably not smaller than 5 μm and smaller than 250 μm, and more preferably not smaller than 20 μm and not larger than 200 μm. If the pitch P of the structures 4c is smaller than 5 μm, part of the light of the transmission wavelength may be reflected in some cases because of difficulties in obtaining the desired shape of the structures 4c and in sharpening a wavelength selection characteristic of the wavelength-selective reflective layer from the general point of view. The occurrence of the above-described partial reflection has such a tendency as generating diffraction and causing even higher-order reflections to be visually recognized, thus making a viewing person feel poorer in transparency. On the other hand, if the pitch P of the structures 4c exceeds 5 mm, a necessary film thickness is increased and flexibility is lost when the shape of the structures 4c necessary for the directional reflection is taken into consideration, thus leading to a difficulty in attaching the directional reflector 1 to a rigid body, such as the window member 10. By setting the pitch P of the structures 4c to be smaller than 250 μm, flexibility is increased to such an extent that the directional reflector 1 can be easily manufactured in a roll-to-roll manner and batch production is not necessary. When the directional reflector 1 is applied to building components such as windows, a length of the directional reflector 1 is about several meters and roll-to-roll production is more suitable than the batch production. By setting the pitch to be not smaller than 20 μm and not larger than 200 μm, productivity can be further increased.

The shape of the structures 4c formed on the surface of the first optical layer 4 is not limited to one type, and the structures 4c may be formed in plural shapes on the surface of the first optical layer 4. When the structures 4c are formed in plural shapes on the surface of the first optical layer 4, a predetermined pattern including the plural shapes of the structures 4c may be cyclically repeated. Alternatively, the plural shapes of the structures 4c may be formed at random (non-cyclically) depending on the desired characteristic.

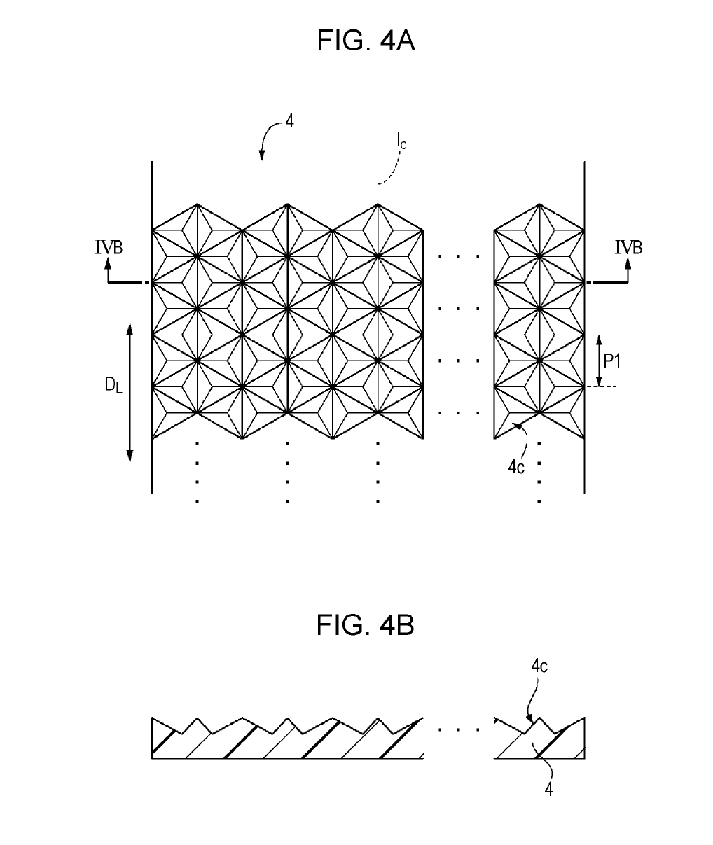

FIG. 4A is a plan view illustrating one example of the shape of the concave-convex surface of the first optical layer, and FIG. 4B is a sectional view of the first optical layer taken along line IVB-IVB in FIG. 4A. The concave-convex surface of the first optical layer 4 is formed, for example, by two-dimensionally arraying the structures 4c each having a recessed corner-cube shape with sloped surfaces of the adjacent structures 4c positioned to face each other. The two-dimensional array of the structures 4c is preferably a two-dimensional array in a close-packed state. The reason is that the close-packed state is effective in increasing a packing rate of the structures 4c and in improving the directional reflection effect of the directional reflector 1.

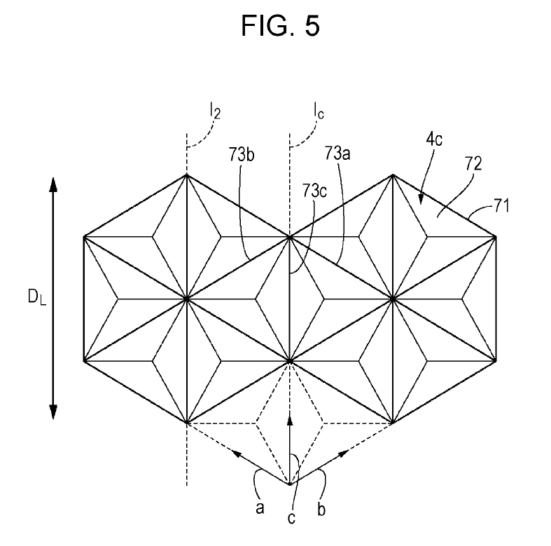

FIG. 5 is an enlarged plan view illustrating, in an enlarged scale, part of the concave-convex surface of the first optical layer illustrated in FIG. 4A. The structure 4c in the form of a recess is a structure having a corner cube shape (which is referred to simply as a “corner cube” hereinafter), and the corner cube is defined by a triangular bottom surface 71 and three sloped surfaces 72 each having a triangular shape. Ridges 73a, 73b and 73c are formed by the sloped surfaces of the structures 4c adjacent to each other. The ridges 73a, 73b and 73c are formed to extend in three directions (hereinafter referred to as “ridge directions”) a, b and c in the concave-convex surface of the first optical layer 4. One ridge direction c of the three ridge directions a, b and c is substantially parallel to a lengthwise direction D_{L} of the belt-shaped directional reflector 1, i.e., to the direction of the specific linear line l₂ in the incident surface S1 of the directional reflector 1.

Herein, the term “corner cube shape” includes, in addition to a precise corner cube shape, a substantially corner cube shape. Examples of the substantially corner cube shape include a corner cube shape having an inclined optical axis, a corner cube shape having one or more curved sloped surfaces, a corner cube shape having a corner angle deviated from 90°, a corner cube shape having a set of grooves in three directions which are deviated from 6-fold symmetry, a corner cube shape in which grooves in specific two directions are deeper than a groove in the other one direction, a corner cube shape in which a groove in specific one direction is deeper than grooves in the other two directions, a corner cube shape in which grooves in three directions intersect at points not exactly aligned with each other, and a corner cube shape having a curvature at a top. Examples of the corner cube having one or more curved sloped surfaces include a corner cube in which three surfaces constituting the corner cube are all curved surfaces, and a corner cube in which one or two of the three surfaces constituting the corner cube are curved surfaces and the remaining surface is a flat surface. Examples of the shape of the curved surface include a curved surface, such as a parabolic surface, a hyperbolic surface, a spherical surface or an elliptic surface, and a free-form surface. The curved surface may be concave or convex. Further, one corner cube may include both of concave and convex curved surfaces.

The first optical layer 4 has, for example, a two-layer structure. In more detail, the first optical layer 4 includes a first base element 4a and a first resin layer 4b, which is formed between the first base element 4a and the reflective layer 3 and which has a concave-convex surface in close contact with the reflective layer 3. Note that the structure of the first optical layer 4 is not limited to the two-layer structure and may be a single-layer structure or a structure having three or more layers.

(Base Element)

The first base element 4a has, by way of example, transparency. The first base element 4a is preferably in the form of a film from the viewpoint of giving the directional reflector 1 with flexibility, but the form of the first base element 4a is not limited to particular one. The first base element 4a can be formed by using, e.g., general high-molecular materials. Examples of the general high-molecular materials include triacetylcellulose (TAC), polyester (TPEE), polyethylene terephthalate (PET), polyimide (PI), polyamide (PA), aramid, polyethylene (PE), polyacrylate, polyethersulfone, polysulfone, polypropylene (PP), diacetyl cellulose, polyvinyl chloride, acryl resin (PMMA), polycarbonate (PC), epoxy resin, urea resin, urethane resin, and melamine resin. However, the materials of the first base element 4a are not particularly limited to the above-mentioned examples. The thickness of each of the first base element 4a and a second base element 5a (described later) is preferably 38 to 100 μm from the viewpoint of productivity, but it is not particularly limited to such a range. The first base element 4a is preferably transparent to an energy ray. The reason is that when the first base element 4a is transparent to an energy ray, an energy-ray curable resin interposed between the first base element 4a and the reflective layer 3 can be cured by irradiating the energy-ray curable resin with the energy ray from the side including the first base element 4a.

(Resin Layer)

The first resin layer 4b has, by way of example, transparency. The first resin layer 4b is obtained, for example, by curing a resin composition. As the resin composition, an energy-ray curable resin capable of curing with irradiation of light or an electron beam, or a thermosetting resin capable of curing with application of heat is preferably used from the viewpoint of easiness in production. As the energy-ray curable resin, a photosensitive resin composition capable of curing with irradiation of light is preferable, and an ultraviolet curable resin capable of curing with application of an ultraviolet ray is most preferable. From the viewpoint of increasing adhesion between the first resin layer 4b and the reflective layer 3, the resin composition preferably further contains a compound containing phosphoric acid, a compound containing succinic acid, or a compound containing butyrolactone. The compound containing phosphoric acid may be, e.g., (meth)acrylate containing phosphoric acid, preferably a (meth)acryl monomer or oligomer having phosphoric acid in a functional group. The compound containing succinic acid may be, e.g., (meth)acrylate containing succinic acid, preferably a (meth)acryl monomer or oligomer having succinic acid in a functional group. The compound containing butyrolactone may be, e.g., (meth)acrylate containing butyrolactone, preferably a (meth)acryl monomer or oligomer having butyrolactone in a functional group.

The ultraviolet curable resin composition contains, e.g., (meth)acrylate and a photopolymerization initiator. The ultraviolet curable resin composition may further contain, if necessary, a photo-stabilizer, a flame retardant, a leveling agent, and/or an anti-oxidant.

As the acrylate, a monomer and/or an oligomer having two or more (meth)acryloyl groups is preferably used. Examples of such a monomer and/or oligomer include urethane (meth)acrylate, epoxy (meth)acrylate, polyester (meth)acrylate, polyol (meth)acrylate, polyether (meth)acrylate, and melamine (meth)acrylate. Herein, the term “(meth)acryloyl group” implies an acryloyl group or a methacryloyl group. The term “oligomer” used herein implies a molecule having molecular weight of 500 or more to 60000 or less.

The photopolymerization initiator used here can be selected, as appropriate, from among general materials. As examples of the general materials, benzophenone derivatives, acetophenone derivatives, and anthraquinone derivatives can be used alone or in a combined manner. An amount of the photopolymerization initiator mixed is preferably 0.1% by mass or more and 10% by mass or less of the solid content. If the amount of the photopolymerization initiator mixed is less than 0.1% by mass, photo-curability is reduced to such a level as being not suitable for industrial production from the practical point of view. On the other hand, if the amount of the photopolymerization initiator mixed exceeds 10% by mass, an odor tends to remain in a formed coating when an amount of light used for the irradiation is small. Herein, the term “solid content” implies all components constituting the first resin layer 4b after being cured. More specifically, for example, the acrylate and the photopolymerization initiator are included in the solid content.

The resin used here preferably causes neither deformations nor cracks even at the process temperature during formation of a dielectric. If the glass transition temperature is too low, this is unsatisfactory in that the resin may be deformed at relatively high temperatures after installation, or the resin shape may be changed during formation of a dielectric. If the glass transition temperature is too high, this is unsatisfactory in that cracks and interfacial peeling tend to occur more easily. In practice, the glass transition temperature is preferably 60° C. or higher and 150° C. or lower and more preferably 80° C. or higher and 130° C. or lower.

Preferably, the resin has such a property that a structure can be transferred to the resin with irradiation of the energy ray or application of heat. Any type of resin, including a vinyl-based resin, an epoxy-based resin, and a thermoplastic resin, can be used as long as the resin satisfies the above-described requirements for the refractive index.

The resin may be mixed with an oligomer to reduce curing shrinkage. The resin may further contain, e.g., polyisocyanate as a curing agent. In consideration of adhesion between the reflective layer 3 and the first resin layer 4b (or the later-described second resin layer 5b), the resin may be further mixed with any of monomers having a hydroxyl group, a carboxyl (carboxylic acid) group and a phosphoric group, polyols, coupling agents such as silane, aluminum and titanium, and various chelating agents.

Note that the contents of the above-mentioned polymers, etc. can be adjusted, as appropriate, depending on, e.g., a dielectric layer or a metal layer included in the reflective layer 3.

(Second Optical Layer)

The second optical layer 5 covers or encloses the concave-convex surface of the first optical layer 4 on which the reflective layer 3 is formed, thereby not only improving the transmission image clarity and the total light transmittance, but also protecting the reflective layer 3. The second optical layer 5 is preferably in the form of a film from the viewpoint of giving the directional reflector 1 with flexibility, but the form of the second optical layer 5 is not limited to particular one. Preferably, one of two principal surfaces of the second optical layer 5 is a smooth surface and the other is a concave-convex surface. The concave-convex surface of the first optical layer 4 and the concave-convex surface of the second optical layer 5 are in such a relation that their concaves and convexes are reversed to each other.

The concave-convex surface of the second optical layer 5 is formed, for example, by a plurality of two-dimensionally arranged the structures 5c. The structures 5c are each, for example, a structure having a recessed shape. The recessed shapes of the structures 5c in the second optical layer 5 are obtained by reversing the convex shapes of the structures 4c in the first optical layer 4 upside down.

The second optical layer 5 has, for example, a two-layer structure. In more detail, the second optical layer 5 includes a second base element 5a and a second resin layer 5b, which is formed between the second base element 5a and the reflective layer 3 and which has a concave-convex surface in close contact with the reflective layer 3. Note that the structure of the second optical layer 5 is not limited to the two-layer structure and may be a single-layer structure or a structure having three or more layers.

The second base element 5a and the second resin layer 5b can be made of the same materials as those of the first base element 4a and the first resin layer 4b, respectively.

The first base element 4a and the second base element 5a preferably have water-vapor transmittances lower than those of the first resin layer 4b and the second resin layer 5b, respectively. For example, when the first resin layer 4b is made of an energy-ray curable resin such as urethane acrylate, the first base element 4a is preferably made of a resin, e.g., polyethylene terephthalate (PET), which has a lower water-vapor transmittance than the first resin layer 4b and which is transparent to the energy ray. Such a feature can reduce diffusion of moisture into the reflective layer 3 from the incident surface 51 or the emergent surface S2 and can suppress deterioration of a metal, etc. contained in the reflective layer 3. Accordingly, durability of the directional reflector 1 can be improved. Note that the water-vapor transmittance of PET having a thickness of 75 μm is about 10 g/m²/day (40° C. and 90% RH).

Preferably, at least one of the first resin layer 4b and the second resin layer 5b contains a functional group having a high polarity, and the content of the functional group differs between the first resin layer 4b and the second resin layer 5b. Preferably, both the first resin layer 4b and the second resin layer 5b include a compound containing phosphoric acid, and the content of the phosphoric acid differs between the first resin layer 4b and the second resin layer 5b. The content of the phosphoric acid differs between the first resin layer 4b and the second resin layer 5b preferably twice or more, more preferably five or more times, and even more preferably ten or more times.

When at least one of the first optical layer 4 and the second optical layer 5 contains a phosphoric compound, the reflective layer 3 preferably contains an oxide, a nitride, or an oxynitride in its surface contacting with the first optical layer 4 or the second optical layer 5 containing a phosphoric compound. More preferably, the reflective layer 3 has a layer, which contains zinc oxide (ZnO) or niobium oxide, in its surface contacting with the first optical layer 4 or the second optical layer 5 containing the phosphoric compound. One reason resides in improving adhesion between the relevant optical layer and the reflective layer 3, i.e., the wavelength-selective reflective layer. Another reason resides in improving an anti-corrosion effect when the reflective layer 3 contains a metal such as Ag. The reflective layer 3 may further contain a dopant, such as Al or Ga. The reason resides in improving film quality and smoothness when a metal oxide layer is formed by, e.g., sputtering.

From the viewpoint of giving the directional reflector 1, the window member 10, etc. with a visually attractive design, at least one of the first resin layer 4b and the second resin layer 5b preferably has a characteristic of absorbing light in the specific wavelength band within the visible range. A pigment dispersed in the resin may be either an organic pigment or an inorganic pigment. In particular, an inorganic pigment having high weatherbility in itself is preferable. Practical examples of the inorganic pigment include zircone gray (Co, Ni-doped ZrSiO₄), praseodymium yellow (Pr-doped ZrSiO₄), chrome-titania yellow (Cr, Sb-doped TiO₂ or Cr, W-doped TiO₂), chrome green (such as Cr₂O₃), peacock ((CoZn)O(AlCr)₂O₃), Victoria green ((Al, Cr)₂O₃), deep blue (CoO.Al₂O₃.SiO₂), vanadium-zirconium blue (V-doped ZrSiO₄), chrome-tin pink (Cr-doped CaO.SnO₂.SiO₂), manganese pink (Mn-doped Al₂O₃), and salmon pink (Fe-doped ZrSiO₄). Examples of the organic pigment include an azo-based pigment and a phthalocyanine pigment.

(Reflective Layer)

The reflective layer 3 is, for example, a wavelength-selective reflective layer for directionally reflecting, of the light incident on the incident surface 51 at the incident angle (θ, φ), the light in the specific wavelength band while transmitting the remaining light in the wavelength bands other than the specific wavelength band, or a reflective layer for directionally reflecting the light incident on the incident surface 51 at the incident angle (θ, φ), or a semitransparent layer that slightly causes scattering and has transparency allowing the opposite side to be visually recognized. The wavelength-selective reflective layer is, for example, a laminate (stacked) film, a transparent conductive layer, or a functional layer. Alternatively, the wavelength-selective reflective layer may be formed by using two or more of the laminate film, the transparent conductive layer, and the functional layer in a combined manner. A mean thickness of the reflective layer 3 is preferably 20 μm or less, more preferably 5 μm or less, and even more preferably 1 μm or less. If the mean thickness of the reflective layer 3 exceeds 20 μm, the length of an optical path in which the transmitted light is refracted is increased, and the transmission image tends to distort in appearance. The reflective layer 3 can be formed, for example, by sputtering, vapor deposition, dip coating, or die coating.

The laminate film, the transparent conductive layer, the functional layer, and the semitransparent layer will be described below in sequence.

(Laminate Film)

The laminate film is, for example, a laminate film formed by alternately stacking a low refractive index layer and a high refractive index layer, which differ from each other in refractive index. As another example, the laminate film is a laminate film formed by alternately stacking a metal layer having a high refractive index in the infrared range, and a high refractive index layer having a high refractive index and serving as an anti-reflection layer in the visible range. An optical transparent layer or a transparent conductive layer can be used as the high refractive index layer.

The metal layer having a high reflectance in the infrared range contains, as a main component, Au, Ag, Cu, Al, Ni, Cr, Ti, Pd, Co, Si, Ta, W, Mo or Ge alone, or an alloy containing two or more selected from among those elements, for example. Of those examples, Ag-, Cu-, Al-, Si- or Ge-based materials are preferable in consideration of practicability. When an alloy is used as the material of the metal layer, the metal layer preferably contains, as a main component, AlCu, Alti, AlCr, AlCo, AlNdCu, AlMgSi, AgPdCu, AgPdTi, AgCuTi, AgPdCa, AgPdMg, AgPdFe, Ag, or SiB, for example. To retard corrosion of the metal layer, the metal layer is preferably mixed with an additional material such as Ti or Nd. In particular, when Ag is used as the material of the metal layer, it is preferable to mix the additional material.

The optical transparent layer is an optical transparent layer having a high refractive index and serving as an anti-reflection layer in the visible range. The optical transparent layer contains, as a main component, a high-dielectric material, e.g., niobium oxide, tantalum oxide, or titanium oxide. The transparent conductive layer contains, as a main component, e.g., ZnO-based oxide or indium-doped tin oxide. The ZnO-based oxide can be, for example, at least one selected from a group including zinc oxide (ZnO), gallium (Ga)- and aluminum (Al)-doped zinc oxide (GAZO), Al-doped zinc oxide (AZO), and gallium (Ga)-doped zinc oxide (GZO).

The refractive index of the high refractive index layer included in the laminate layer is preferably in the range of 1.7 or more to 2.6 or less, more preferably 1.8 or more to 2.6 or less, and more preferably 1.9 or more to 2.6 or less. This is because, by setting the refractive index as mentioned above, anti-reflection can be realized in the visible range with a film being so thin as not to cause cracks. Note that the refractive index is measured at a wavelength of 550 nm. The high refractive index layer is, for example, a layer containing a metal oxide as a main component. From the viewpoint of relaxing stresses in the layer and suppressing the occurrence of cracks, it is preferable to use a metal oxide other than the zinc oxide in some cases. In such a case, at least one selected from a group including niobium oxide (e.g., niobium pentoxide), tantalum oxide (e.g., tantalum pentoxide), and titanium oxide is preferably used. A thickness of the high refractive index layer is preferably 10 nm or more and 120 nm or less, more preferably 10 nm or more and 100 nm or less, and even more preferably 10 nm or more and 80 nm or less. If the layer thickness is smaller than 10 nm, the high refractive index layer is more apt to reflect visible light. On the other hand, if the layer thickness exceeds 120 nm, the high refractive index layer is more apt to reduce its transmittance and to cause cracks.

The laminate film is not limited to a thin film made of the inorganic material, and it may be formed by stacking a thin film made of a high-molecular material and a layer containing fine particles, etc. dispersed in a high-molecular material. For the purpose of preventing oxidation degradation of an underlying layer when the optical transparent layer is formed, a thin buffer layer made of, e.g., Ti and having a thickness of several nanometers may be disposed at the interface of the optical transparent layer to be formed. Herein, the term “buffer layer” implies a layer that is self-oxidized to suppress oxidation of an underlying metal layer, for example, when an overlying layer is formed.

(Transparent Conductive Layer)

The transparent conductive layer is a layer containing, as a main component, an electrically conductive material having transparency in the visible range. More specifically, the transparent conductive layer contains, as a main component, a transparent conductive material, e.g., tin oxide, zinc oxide, a material containing carbon nanotubes, indium-doped tin oxide, indium-doped zinc oxide, and antimony-doped tin oxide. A layer alternatively usable here may contain nanoparticles of the above-mentioned materials, or nanoparticles, nanorods or nanowires of a conductive material, e.g., a metal, which are dispersed in a resin at a high density.

(Functional Layer)

The functional layer contains, as a main component, a chromic material of which reflective performance, for example, is reversibly changed upon application of an external stimulus. The term “chromic material” implies a material reversibly changing its structure upon application of an external stimulus, such as heat, light, or intrusive molecules. Examples of the chromic material usable here include a photochromic material, a thermochromic material, a gaschromic material, and an electrochromic material.

The photochromic material is a material reversibly changing its structure by the action of light. The photochromic material can reversibly change various physical properties, such as reflectance and color, upon irradiation of light, e.g., an ultraviolet ray. Transition metal oxides, such as TiO₂, WO₃, MoO₃, and Nb₂O₅ that are doped with Cr, Fe or Ni, for example, can be used as the photochromic material, a thermochromic material. Further, wavelength selectivity can be increased by stacking a layer of the photochromic material and a layer having a different refractive index from that of the former layer.

The thermochromic material is a material reversibly changing its structure by the action of heat. The thermochromic material can reversibly change various physical properties, such as reflectance and color, upon application of heat. For example, VO₂ can be used as the thermochromic material. Other elements, such as W, Mo and F, may also be added for the purpose of controlling the transition temperature and the transition curve. Alternatively, a laminate structure may be formed by sandwiching a thin film containing, as a main component, the thermochromic material, e.g., VO₂, between anti-reflection layers each containing, as a main component, a high refractive index material, e.g., TiO₂ or ITO.

A photonic lattice, such as a cholesteric liquid crystal, can also be used. The cholesteric liquid crystal can selectively reflect light at a wavelength depending on an interlayer distance, and the interlayer distance is changed depending on temperature. Therefore, the physical properties, such as reflectance and color, of the cholesteric liquid crystal can be reversibly changed upon heating. In this connection, a reflection band can be widened by using several cholesteric liquid crystals having different interlayer distances.

The electrochromic material is a material reversibly changing various physical characteristics, such as reflectance and color, by the action of electricity. The electrochromic material can be prepared, for example, as a material reversibly changing its structure upon application of voltage, for example. More specifically, a reflective light control material changing its reflection characteristic with doping or undoping of a proton, for example, can be used as the electrochromic material. The term “reflective light control material” implies a material capable of selectively controlling its optical property to desired one of a transparent state, a mirror state, and an intermediate state therebetween upon application of an external stimulus. Examples of the reflective light control material usable here include an alloy material containing, as a main component, a magnesium-nickel alloy material or a magnesium-titanium alloy material, WO₃, and materials in which needle crystals with selective reflectivity are enclosed in microcapsules.

In practice, the functional layer can be constituted, for example, by successively stacking, on the second optical layer 5, the above-described alloy layer, a catalyst layer containing, e.g., Pd, a thin buffer layer made of, e.g., Al, an electrolyte layer made of, e.g., Ta₂O₅, an ion storage layer made of, e.g., WO₃ containing protons, and the transparent conductive layer. Alternatively, the functional layer can be constituted, for example, by successively stacking, on the second optical layer 5, the transparent conductive layer, the electrolyte layer, an electrochromic layer made of, e.g., WO₃, and the transparent conductive layer. In such a laminate structure, when a voltage is applied between the transparent conductive layer and an opposed electrode, protons contained in the electrolyte layer are doped into or undoped from the alloy layer. As a result, the transmittance of the alloy layer is changed. Further, in order to increase the wavelength selectivity, the electrochromic material is preferably laminated with a high refractive index material, such as TiO₂ or ITO. As another usable laminate structure, the transparent conductive layer, an optical transparent layer including microcapsules dispersed therein, and a transparent electrode may be stacked on the second optical layer 5. In that structure, when a voltage is applied between both the transparent electrodes, a transmissive state can be obtained in which needle crystals in the microcapsules are uniformly oriented, and when a voltage is eliminated, a wavelength-selective reflective state can be obtained in which the needle crystals are oriented at random.

(Semitransparent Layer)

A semitransparent layer is a semitransparent reflective layer. Examples of the semitransparent reflective layer include a thin metal layer, a thin metal nitride layer, etc., each containing a semiconductive material. From the viewpoint of anti-reflection, color tone control, improved chemical wetting, and higher reliability with respect to environmental degradation, the semitransparent reflective layer is preferably formed in a laminate structure including, e.g., an oxide layer, a nitride layer, or an oxynitride layer.

The metal layer having a high refractive index in the visible range and the infrared range can be made of a material containing, as a main component, Au, Ag, Cu, Al, Ni, Cr, Ti, Pd, Co, Si, Ta, W, Mo or Ge alone, or an alloy containing two or more selected from among those elements, for example. Of those examples, Ag-, Cu-, Al-, Si- or Ge-based materials are preferable in consideration of practicability. To retard corrosion of the metal layer, the metal layer is preferably mixed with an additional material such as Ti or Nd. The metal nitride layer can be made of, e.g., TiN, CrN or WN.

A thickness of the semitransparent layer can be set to the range of, e.g., 2 nm or more to 40 nm or less. However, the thickness of the semitransparent layer is not limited to such a particular range because the semitransparent layer may have any desired thickness as long as it has semitransparency in the visible range and the near infrared range. Herein, the term “semitransparency” implies that the transmittance at wavelengths of 500 nm or longer to 1000 nm or shorter is 5% or more and 70% or less, preferably 10% or more and 60% or less, and more preferably 15% or more and 55% or less. Also, the term “semitransparent layer” implies a reflective layer having the transmittance of 5% or more and 70% or less, preferably 10% or more and 60% or less, and more preferably 15% or more and 55% or less at wavelengths of 500 nm or longer to 1000 nm or shorter.

[Functions of Directional Reflector]

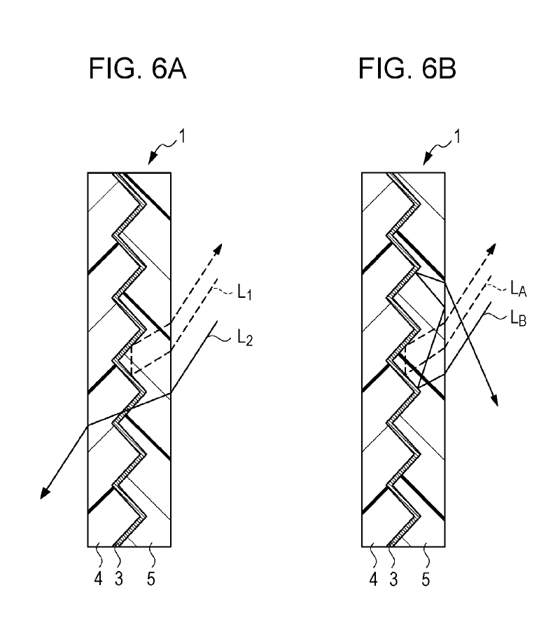

FIGS. 6A and 6B are each a sectional view to explain one example of functions of the directional reflector. As illustrated in FIG. 6A, part of an infrared ray L₁ of sunlight incident on the directional reflector 1 is directionally reflected toward the sky in a substantially reversed relation to the direction of the incident light. However, visible light L₂ passes through the directional reflector 1.

Further, as illustrated in FIG. 6B, light incident on the directional reflector 1 and reflected by the reflective surface of the reflective layer 3 is separated into a component L_{A} reflected toward the sky and a component L_{B} not reflected toward the sky at a proportion depending on the incident angle. The component L_{B} not reflected toward the sky is totally reflected at the interface between the second optical layer 5 and air and is then finally reflected in a direction differing from the incident direction.

As the proportion of the component L_{B} not reflected toward the sky increases, a proportion at which the incident light is reflected toward the sky decreases. In order to increase the proportion at which the incident light is reflected toward the sky, it is effective to properly design the shape of the reflective layer 3, i.e., the shape of the structure 4c of the first optical layer 4.

[Construction of Roll-Shaped Master]

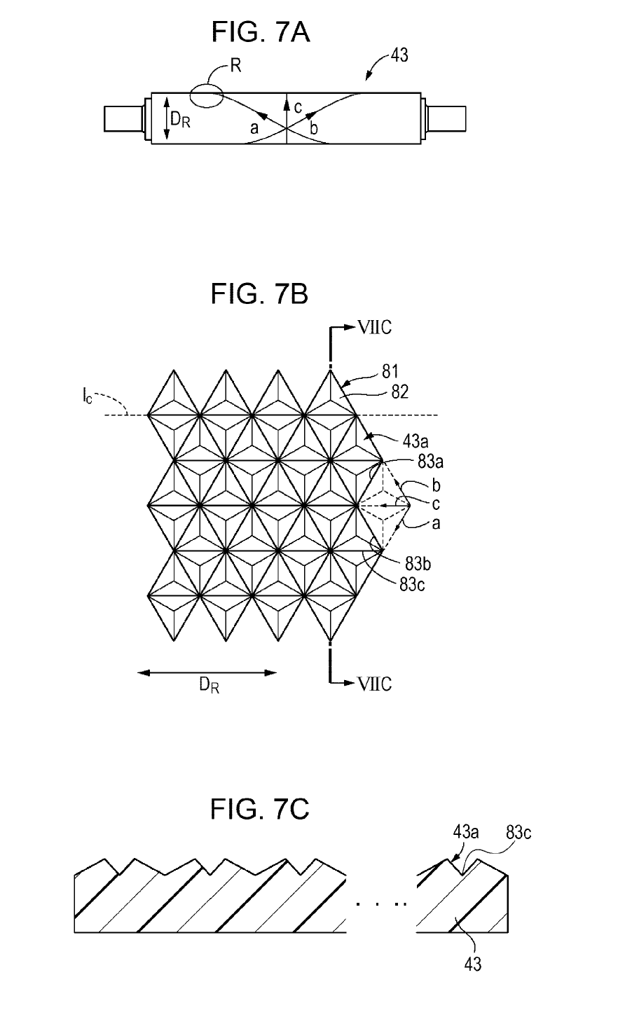

FIG. 7A is a perspective view illustrating an overall appearance of a roll-shaped master 43, FIG. 7B is an enlarged plan view illustrating, in an enlarged scale, a region R illustrated in FIG. 7A, and FIG. 7C is a sectional view taken along line VIIC-VIIC in FIG. 7B. The roll-shaped master 43 has a cylindrical surface that is formed as a concave-convex surface. The concave-convex surface of the first optical layer 4 is formed by transferring the concave-convex surface of the roll-shaped master 43 to, e.g., a film. The concave-convex surface of the roll-shaped master 43 is formed by arraying a large number of structures 43a each having a convex corner-cube shape. The convex shape of the structure 43a of the roll-shaped master 43 is equivalent to that obtained by reversing the concave shape of the structure 4c of the first optical layer 4.

The convex structure 43a is a structure having a corner cube shape defined by a triangular bottom surface 81 and three sloped surfaces 82 each having a triangular shape. Grooves 83a, 83b and 83c are formed by the sloped surfaces of the adjacent structures 43a. The grooves 83a, 83b and 83c are formed to extend in three directions (hereinafter referred to also as “groove directions”) a, b and c in the cylindrical surface of the roll-shaped master 43. One groove direction c of the three groove directions a, b and c is substantially parallel to a radial direction D_{R} of the roll-shaped master 43. By forming the concave-convex surface of the first optical layer 4 by using the roll-shaped master 43, the ridge 73c can be formed in a direction substantially parallel to a lengthwise direction D_{L} of the belt-shaped directional reflector 1, as illustrated in FIG. 5.

[Machining Apparatus]

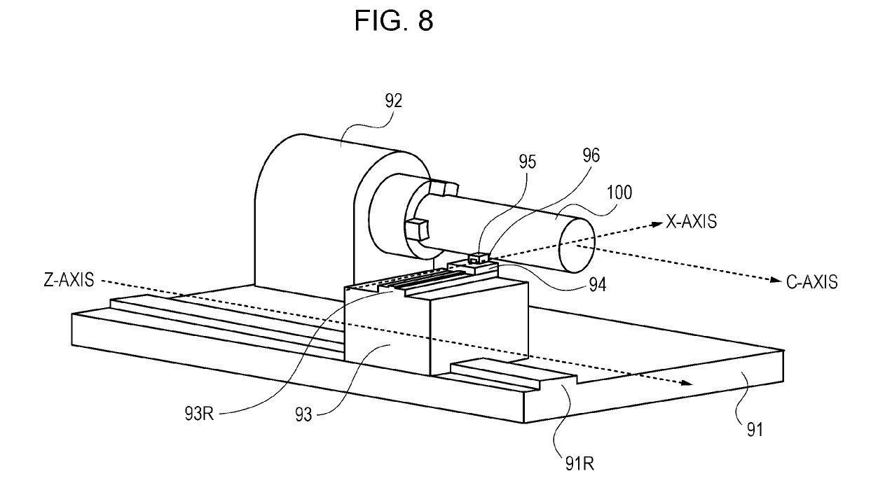

FIG. 8 is a perspective view illustrating one example of construction of a machining apparatus for fabricating the roll-shaped master. As illustrated in FIG. 8, the machining apparatus includes a base 91, a support 92, a first slide 93, and a second slide 94. The support 92 and the first slide 93 are disposed on the base 91. The second slide 94 is disposed on the first slide 93.

The support 92 supports one end of a workpiece 100 and can be driven to rotate about a rotation axis (C-axis) that is aligned with a central axis of the supported workpiece 100. The workpiece 100 has a cylindrical shape, and a large number of corner cubes (also called “corner-cube retroreflection elements”) are formed in a cylindrical surface of the workpiece 100. The workpiece 100 on which the large number of corner cubes are to be formed can be made of, e.g., oxygen free copper, aluminum, brass, or a Ni-P plated film. Synthetic resin materials can also be used for the workpiece 100. Examples of the synthetic resin materials include polycarbonate-based resin and acryl-based resin.

A first rail 91R for guiding the first slide 93 is formed on the base 91. The first rail 91R has a linear shape and is formed parallel to the C-axis of the cylindrical workpiece 100 supported on the support 92. On the linear first rail 91R, a Z-axis (slide axis) is set parallel to a direction in which the first rail 91R is extended. In other words, the Z-axis set on the first rail 91R and the C-axis set on the cylindrical workpiece 100 are parallel to each other. The first slide 93 is guided by the first rail 91R to be movable on the base 91 in the Z-axis direction, i.e., in the direction parallel to the rotation axis (C-axis) of the cylindrical workpiece 100.

On the first slide 93, a linear second rail 93R for guiding the second slide 94 is formed to extend perpendicularly to the first rail 91R. On the linear second rail 93R, an X-axis (slide axis) is set parallel to a direction in which the second rail 93R is extended. In other words, the X-axis set on the second rail 93R is orthogonal to the Z-axis set on the first rail 91R and the C-axis set on the cylindrical workpiece 100. The second slide 94 is guided by the second rail 93R to be movable on the base 91 in the X-axis direction, i.e., in the direction in which the second slide 94 is moved closer to and away from the workpiece 100.

The second slide 94 includes a bite support 95 for supporting a bite 96, i.e., a cutting tool. The bite support 95 can adjust an angle at which the bite 96 is pressed against the workpiece surface. The bite 96 can be made of, e.g., a single-crystal diamond, a polycrystalline diamond, or one of various alloys adapted for bites (cutting tools). Among those examples, the single-crystal diamond is particularly preferable. The reason is that the single-crystal diamond is superior in wear resistance and shape accuracy of the bite and can hold a V-shaped groove at a desired angle with high accuracy.

(Workpiece)

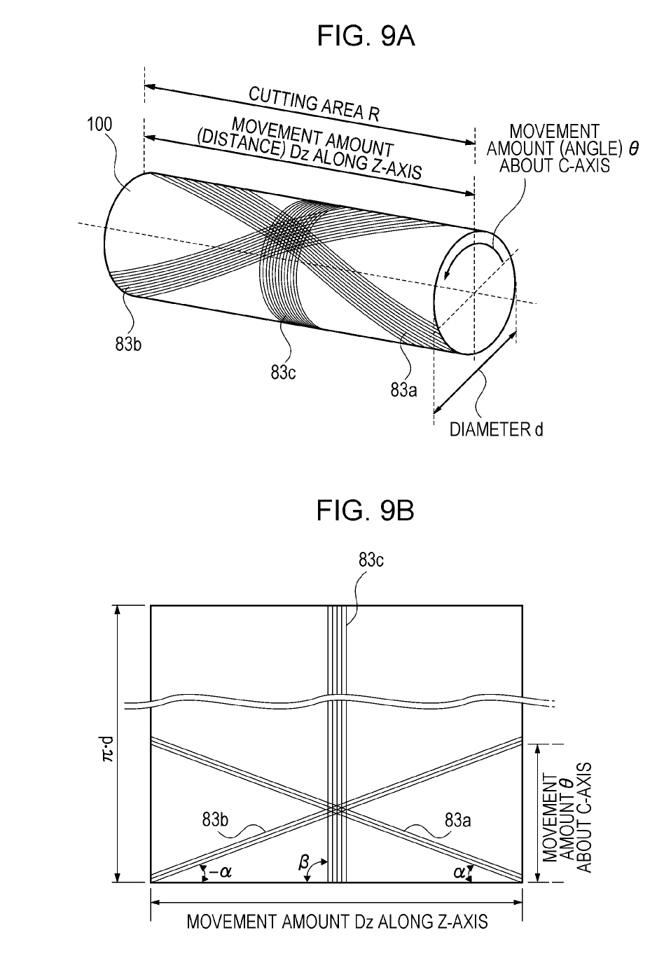

FIG. 9A is a perspective view illustrating an overall appearance of the workpiece, and FIG. 9B is a development view of the workpiece illustrated in FIG. 9A. As illustrated in FIG. 9A, the workpiece 100 has a cylindrical shape with a diameter d, and a corner cube pattern is formed on the workpiece 100 by forming many V-shaped grooves 83a, 83b and 83c in a cutting region R of the cylindrical surface thereof. A width of the cutting region R corresponds to a movement amount Dz along the Z-axis. Herein, the movement amount Dz along the Z-axis represents an amount by which the first slide 93 is moved in the Z-axis direction, i.e., an amount by which the bite 96 is moved in the Z-axis direction, during the cutting of the workpiece 100. A movement amount θ about the C-axis represents an angle by which the workpiece 100 is rotated while the first slide 93 is moved through a distance corresponding to the movement amount Dz along the Z-axis during the cutting. Note that, although FIG. 9A illustrates only the cutting region R of the workpiece 100, support regions (not shown) for supporting the workpiece 100, etc. are also set in end portions thereof.

As illustrated in FIG. 9B, the development view of the workpiece 100 represents a rectangular shape having sizes of vertical length (π·d)×horizontal length (movement amount Dz along the Z-axis). Angles α and −α of the V-shaped grooves 83a and 83b in the surface of the workpiece 100 with respect to the rotation axis (C-axis) of the workpiece 100 are expressed by the following formulae (1a) and (1b), respectively:

α=Tan⁻¹(π·d·θ/Dz) (1a)

−α=−Tan⁻¹(π·d·θ/Dz) (1b)

(where d: diameter of the workpiece 100, Dz: amount by which the first slide 93 is moved in the Z-axis direction during the cutting, and θ: angle by which the workpiece 100 is rotated while the first slide 93 is moved through the movement amount Dz along the Z-axis during the cutting).

A deviation γ between a curved surface formed when the angle α is in the range of 0°<α<90° and a flat plane sharing a bottom side of the same V-shaped groove is expressed by the following formula (2):

γ=p·tan α/(π·d) (2)

(where p: pitch distance of the plural V-shaped grooves)

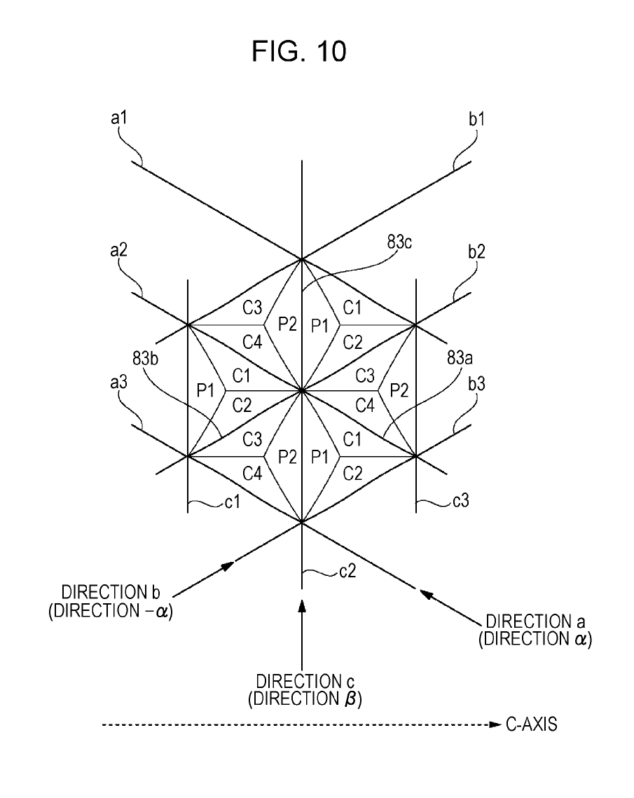

FIG. 10 is a diagram illustrating machining directions for the V-shaped grooves. As illustrated in FIG. 10, the V-shaped grooves 83a, 83b and 83c extending in three different directions, i.e., in the direction a, the direction b, and the direction c, are formed in the workpiece surface. More specifically, for example, the V-shaped groove 83a extending in a direction of the angle α, the V-shaped groove 83b extending in a direction of the angle −α, and the V-shaped groove 83c extending in a direction of an angle β are formed in the workpiece surface. Herein, the angle α rotated clockwise with the rotation axis (C-axis) of the workpiece 100 serving as a reference axis is denoted by “+α (or α)”, and the angle α rotated counterclockwise contrary to the above case is denoted by “−α”. Preferably, the angle α is in the range of 0°<α<90°, the angle −α is in the range of −90°<−α<0°, and the angle β is 90°.

The respective angles (α, −α, β) of the three types of V-shaped grooves formed in the workpiece surface are more preferably equal to angles (30°, −30°, 90°). As described above, the angles (α, −α, β) of the V-shaped grooves 83a, 83b and 83c represent respective angles of the V-shaped grooves 83a, 83b and 83c with respect to the rotation axis (C-axis) of the workpiece 100. When the angle α of the V-shaped groove 83a is in the range of 0°<α<90° and the angle −α of the V-shaped groove 83b is in the range of −90°<−α<0°, the V-shaped grooves 83a and 83b are spirally formed in the workpiece surface, and side surfaces of those V-shaped grooves are each formed as a curved surface.

The corner cube pattern is formed by groups of the V-shaped grooves (a1, a2, a3, . . . , b1, b2, b3, . . . and c1, c2, c3, . . . ) extending in three directions, i.e., in the direction a, the direction b, and the direction c. The corner cube pattern is constituted by a large number of corner cubes which are two-dimensionally arrayed. Preferably, two of three reflective side surfaces constituting one corner cube are formed as curved surfaces, and the remaining reflective side surface is formed as a flat surface. For example, surfaces C1 to C4 of the corner cubes, which are formed by two groups of the V-shaped grooves (a1, a2, a3, . . . and b1, b2, b3, . . . ) extending in the direction a and the direction b are formed as curved surfaces. Also, surfaces P1 and P2 of the corner cubes, which are formed by one group of the V-shaped grooves (c1, c2, c3, . . . ) extending in the direction c are formed as flat surfaces. Thus, two opposing surfaces of the adjacent corner cubes are both either curved surfaces or flat surfaces.

[Method of Machining Workpiece]

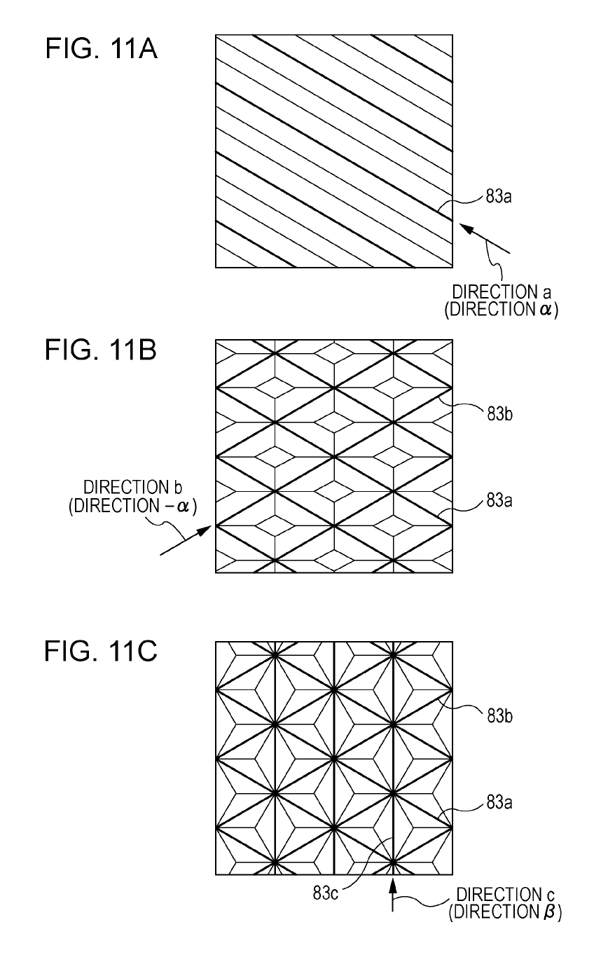

One example of a method of machining the workpiece according to the first embodiment will be described below with reference to FIGS. 11A to 11C. With the method of machining the workpiece according to the first embodiment, two of the three surfaces constituting the corner cube are machined into the curved surfaces by using the bite 96 having a predetermined opening angle, and the remaining surface is machined into the flat surface by using the bite 96 having a predetermined opening angle.

First, the first slide 93 is driven to align a tip position of the bite 96 with one end of the cutting region R of the workpiece 100. Next, the second slide 94 is driven to press the bite 96 against the one end of the cutting region R by a certain force, and the workpiece 100 is rotated counterclockwise, for example, thereby starting the machining of the V-shaped groove 83a extending in the direction of the angle α (e.g., the angle of 30°). Next, while continuing the rotation of the workpiece 100, the first slide 93 is driven to move the bite 96 in the Z-axis direction. At that time, a rotating speed of the workpiece 100 and a moving speed of the first slide 93 are synchronized with each other such that the V-shaped groove 83a is formed at the angle α (e.g., the angle of 30°) with respect to the rotation axis (C-axis) of the workpiece 100. As a result, the V-shaped groove 83a extending in the direction of the angle α is formed with the bite 96 drawing a predetermined locus on the workpiece surface. Next, when the bite 96 reaches the other end of the cutting region R, the second slide 94 is driven to move the bite 96 away from the workpiece surface, thereby stopping the machining of the V-shaped groove 83a.

Next, the first slide 93 is driven to return the bite 96 to one end of the cutting region R of the workpiece 100, and to align the tip position of the bite 96 with a position shifted by a predetermined pitch in the radial direction from the position where the V-shaped groove 83a has been previously machined. Next, the V-shaped groove 83a is machined again in a similar manner to that when the V-shaped groove 83a has been previously machined. By repeating the above-described machining, a large number of V-shaped grooves 83a extending in the direction of the angle α are formed parallel to each other in the workpiece surface, as illustrated in FIG. 11A.

Next, the cutting is repeated in a similar manner to that when the V-shaped groove 83a extending in the direction of the angle α has been formed, except for rotating the workpiece 100 in the reversed direction (e.g., clockwise). As a result, a large number of V-shaped grooves 83b extending in the direction of the angle −α (e.g., the direction of the angle of −30°) are formed parallel to each other in the workpiece surface. Hence, many V-shaped grooves 83a and 83b extending in two directions of the angle α and the angle −α are formed as illustrated in FIG. 11B.

Next, the first slide 93 is driven to adjust the tip position of the bite 96 such that, during the cutting, the bite 96 passes an intersection between the V-shaped grooves 83a and 83b extending in the two directions, which have been formed as described above. Next, the second slide 94 is driven to press the bite 96 against the one end of the cutting region R by a certain force, and the workpiece 100 is rotated, thereby starting the machining of the V-shaped groove 83c. Next, while continuing the rotation of the workpiece 100, the first slide 93 is held at the same position on the Z-axis. As a result, the V-shaped groove 83c extending in the direction of the angle β (e.g., the angle of 90°) (i.e., in the radial direction) is formed in the workpiece surface. The above-described cutting is repeated while the tip of the bite 96 is moved at a predetermined pitch in the Z-axis direction from the one end to the other end of the cutting region R. Consequently, a large number of V-shaped grooves 83c extending in the direction of the angle β are formed parallel to each other in the workpiece surface, as illustrated in FIG. 11C.

Thus, the objective roll-shaped master 43 is obtained.

[Apparatus for Forming First Optical Layer]

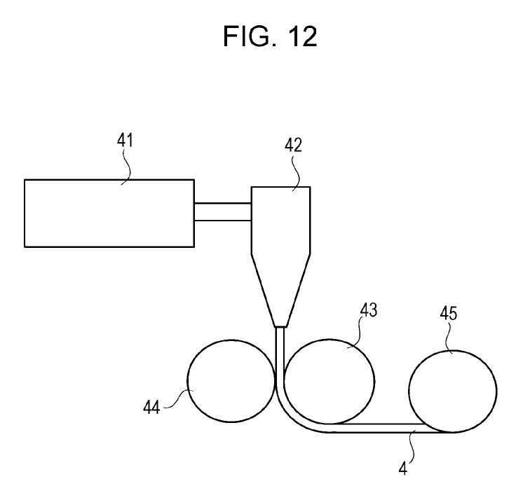

FIG. 12 is a schematic view illustrating one example of construction of a forming apparatus for forming the first optical layer. As illustrated in FIG. 12, the forming apparatus includes an extruder 41, a T-die 42, the roll-shaped master 43, a thickness adjusting roll 44, and a take-up roll 45.

The extruder 41 melts a resin material fed from a hopper (not shown) and supplies the molten resin material to the T-die 42. The T-die 42 is a die having a linear (“−”-shaped) opening and ejects the resin material supplied from the extruder 41 while spreading it to the width of a film to be formed. The roll-shaped master 43 transfers a concave-convex shape to the film ejected from the T-die 42. The thickness adjusting roll 44 adjusts the thickness of the film ejected from the T-die 42. The take-up roll 45 takes up the first optical layer 4 thus extruded into the form of a belt.

[Apparatus for Manufacturing Directional Reflector]

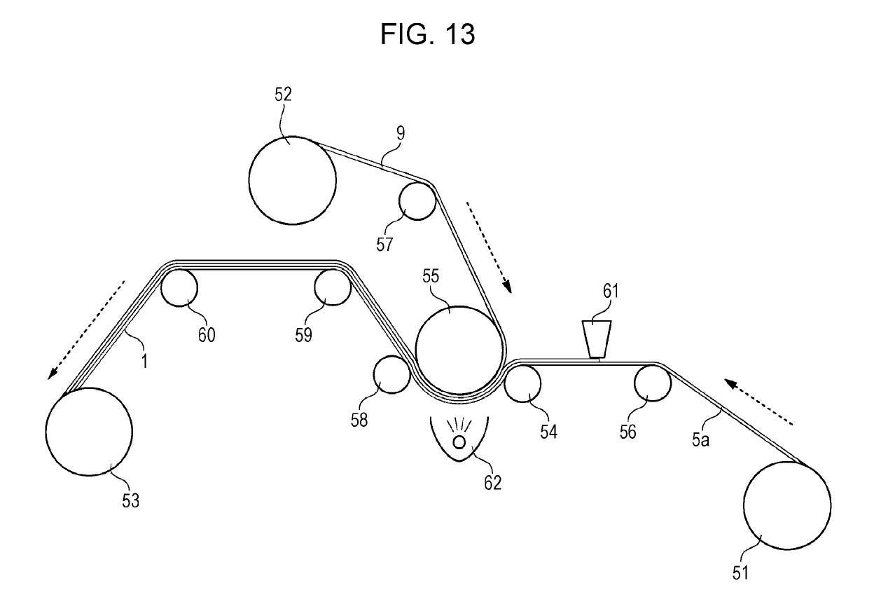

FIG. 13 is a schematic view illustrating one example of construction of a manufacturing apparatus for manufacturing the directional reflector according to the first embodiment. As illustrated in FIG. 13, the manufacturing apparatus includes a base element supply roll 51, an optical layer supply roll 52, a take-up roll 53, laminating rolls 54 and 55, guide rolls 56 to 60, a coating device 61, and an irradiation device 62.

The base element supply roll 51 and the optical layer supply roll 52 hold respectively the belt-shaped base element 5a and a belt-shaped optical layer 9 including the reflective layer affixed thereto, which are wound into roll-like shapes around them. The belt-shaped base element 5a and the reflective-layer affixed optical layer 9 can be continuously let out from the rolls 51 and 52, respectively, with the aid of the guide rolls 56 and 57, etc. Arrows in FIG. 13 represent directions in which the belt-shaped base element 5a and the reflective-layer affixed optical layer 9 are conveyed. The reflective-layer affixed optical layer 9 is the second optical layer 5 on which the reflective layer 3 is formed.

The take-up roll 53 is arranged to be able to take up the belt-shaped directional reflector 1 fabricated by the illustrated manufacturing apparatus. The laminating rolls 54 and 55 are arranged to be able to feed the reflective-layer affixed optical layer 9 let out from the optical layer supply roll 52 and the base element 5a let out from the base element supply roll 51 in a nipped state. The guide rolls 56 to 60 are arranged along conveying paths within the manufacturing apparatus such that the belt-shaped reflective-layer affixed optical layer 9, the belt-shaped base element 5a, and the belt-shaped directional reflector 1 can be conveyed as intended. Materials of the laminating rolls 54 and 55 and the guide rolls 56 to 60 are not limited to particular ones. A metal such as stainless steel, rubber, silicone, etc. can be selectively used, as appropriate, depending on the desired roll characteristics.

The coating device 61 can be prepared as a device including a coating unit, such as a coater. As the coater, a gravure coater, a wiper, a die, or one of other ordinary coaters can be used, as appropriate, in consideration of physical properties of the resin composition to be coated, etc. The irradiation device 62 is a device for irradiating an ionizing ray, e.g., an electron ray, an ultraviolet ray, a visible ray, or a gamma ray.

[Method of Manufacturing Directional Reflector]

One example of a method of manufacturing the directional reflector according to the first embodiment will be described below with reference to FIGS. 12 to 16. Note that part or the whole of a manufacturing process described below is preferably performed in a roll-to-roll manner in consideration of productivity, except for a step of fabricating a mold.

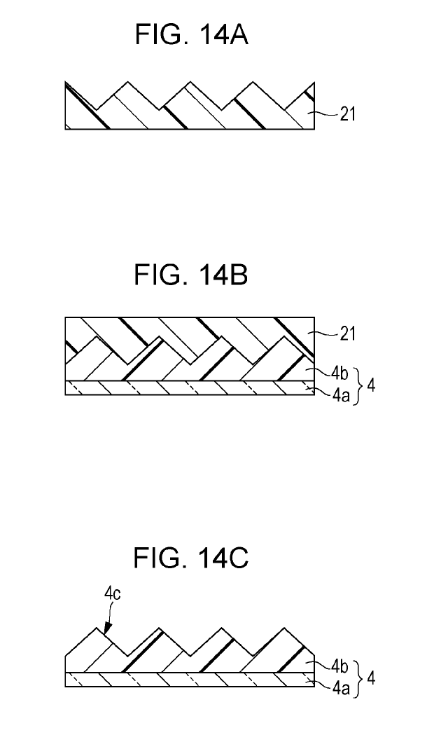

First, as illustrated in FIG. 14A, a master 21 having the reversed shapes of the structures 4c is formed by, e.g., bite machining or laser machining. The master 21 is preferably prepared as the roll-shaped master 43. The reason is that the roll-shaped master 43 can continuously form the first optical layer 4 in the form of a belt in the roll-to-roll manner. Next, as illustrated in FIG. 14B, the concave-convex shape of the master 21 is transferred to a resin material in the form of a film by utilizing, e.g., a fusion extrusion process or a transfer process. The transfer process can be practiced, for example, by a method of pouring an energy-ray curable resin into a mold and irradiating the poured resin with an energy ray, or by a method of applying heat and/or pressure to a resin for transfer of the shape. Through the above-described steps, as illustrated in FIG. 14C, the first optical layer 4 having the structures 4c on one principal surface thereof is formed.

The method of applying heat and/or pressure to a resin for transfer of the shape by using the forming apparatus, illustrated in FIG. 12, will be described below in detail. First, the resin material extruded in the molten state from the extruder 31 is successively supplied to the T-die 42, and the resin material in the form of a film is continuously ejected from the T-die 42. Next, the film ejected from the T-die 42 is nipped between the roll-shaped master 43 and the thickness adjusting roll 44. As a result, the concave-convex shape of the roll-shaped master 43 is transferred to the film.

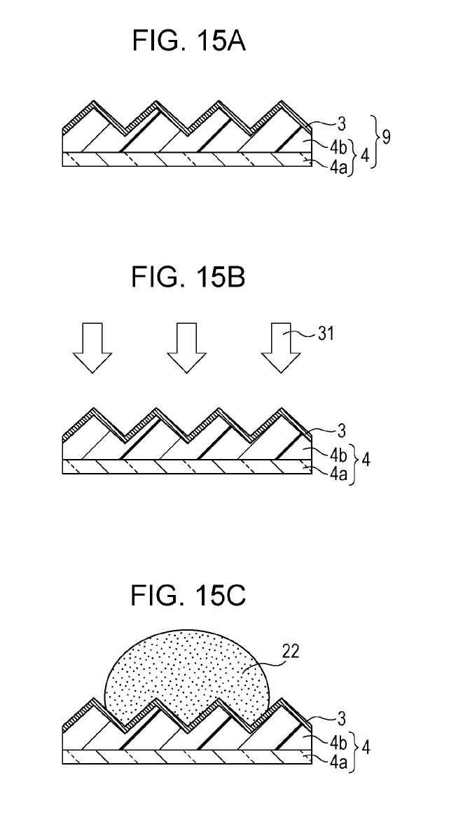

Next, as illustrated in FIG. 15A, the reflective layer 3 is formed on the concave-convex surface of the first optical layer 4. As a result, the reflective-layer affixed optical layer 9 is fabricated. The reflective layer 3 can be formed, for example, by using at least one of a physical vapor deposition process or a chemical vapor deposition process. In particular, a sputtering process is preferably used. Next, as illustrated in FIG. 15B, an annealing process, denoted by 31, is carried out on the reflective layer 3 if necessary.

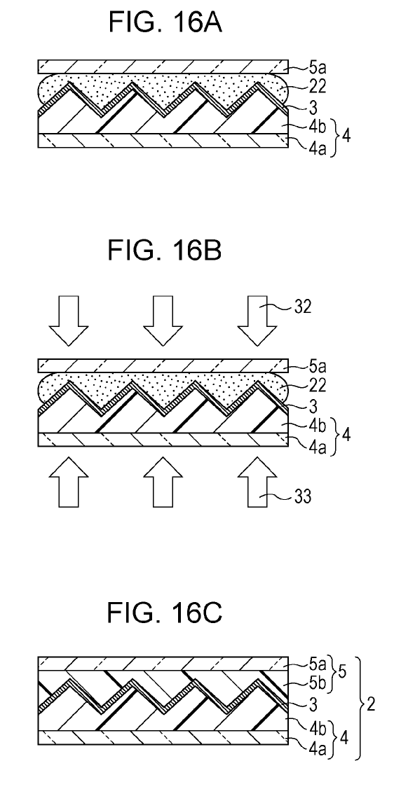

Next, as illustrated in FIG. 15C, a resin 22 in a state not yet cured is coated on the reflective layer 3. For example, an energy-ray curable resin or a thermosetting resin can be used as the resin 22. Preferably, the resin 22 further contains a cross-linking agent. The reason is that the cross-linking agent can make the resin resistant against heat without greatly changing the storage modulus at room temperature. The energy-ray curable resin is preferably an ultraviolet curable resin. Next, as illustrated in FIG. 16A, a laminate is formed by coating the base element 5a on the resin 22. Next, as illustrated in FIG. 16B, the resin 22 is cured, for example, by irradiation of an energy ray 32 or by heating denoted by 32. At that time, pressure is applied, as denoted by 33, to the laminate if necessary. The energy ray can be, e.g., an electron ray, an ultraviolet ray, a visible ray, or a gamma ray. From the viewpoint of production equipment, the ultraviolet ray is preferably used. Preferably, an integrated irradiation amount is selected, as appropriate, in consideration of the curing characteristic of the resin, suppression of yellowing of the resin and the base element, etc. As a result, as illustrated in FIG. 16C, the second optical layer 5 is formed on the reflective layer 3 and the belt-shaped directional reflector 1 is obtained.

A method of forming the second optical layer 5 by using the manufacturing apparatus, illustrated in FIG. 13, will be described below in detail. First, the base element 5a is let out from the base element supply roll 51, and the let out base element 5a is guided to pass under the coating device 61 through the guide roll 56. Next, an ionizing-ray curable resin is coated by the coating device 61 on the base element 5a passing under the coating device 61. Next, the base element 5a coated with the ionizing-ray curable resin is conveyed toward the laminating rolls 54 and 55. On the other hand, the reflective-layer affixed optical layer 9 is let out from the optical layer supply roll 52 and is conveyed toward the laminating rolls 54 and 55 through the guide roll 57.

Next, the base element 5a and the reflective-layer affixed optical layer 9, each conveyed as described above, are sandwiched between the laminating rolls 54 and 55 without allowing bubbles to enter between the base element 5a and the reflective-layer affixed optical layer 9, thereby laminating the reflective-layer affixed optical layer 9 onto the base element 5a. Next, the base element 5a including the laminated reflective-layer affixed optical layer 9 is conveyed along an outer circumferential surface of the laminating roll 55 while the irradiation device 62 irradiates the ionizing-ray curable resin with the ionizing ray from the side including the base element 5a, thereby curing the ionizing-ray curable resin. As a result, the base element 5a and the reflective-layer affixed optical layer 9 are stuck to each other with the ionizing-ray curable resin interposed therebetween, and the objective long directional reflector 1 is fabricated. Next, the fabricated belt-shaped directional reflector 1 is conveyed to the take-up roll 53 through the guide rolls 58, 59 and 60 such that the directional reflector 1 is taken up by the take-up roll 53. As a result, a stock roll in the rolled form of the belt-shaped directional reflector 1 is obtained.

[Method of Attaching Directional Reflector]

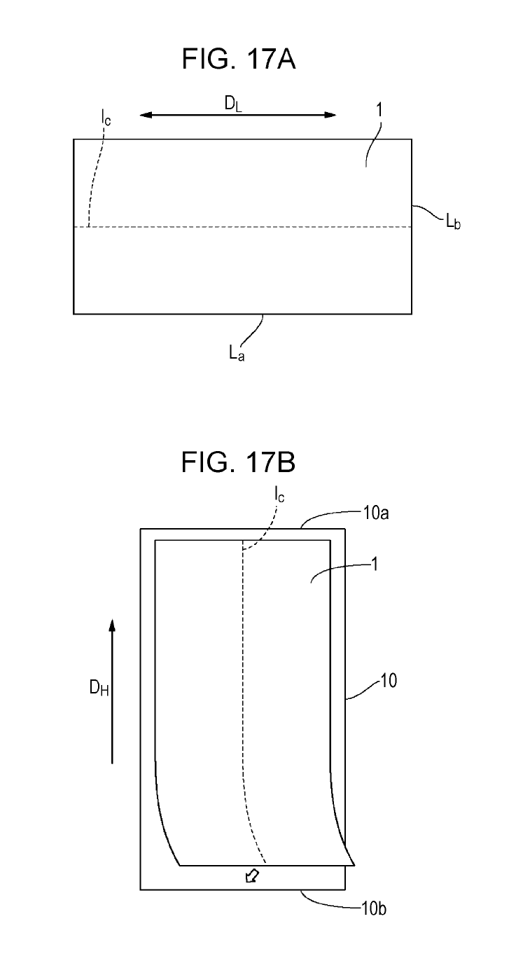

FIGS. 17A and 17B are illustrations to explain one example of a method of attaching the directional reflector according to the first embodiment. The window member 10 employed in a recent tall structure, such as a high-rise building, generally has a rectangular shape with a vertical size being larger than a horizontal size. Therefore, the following description is made in connection with an example in which the directional reflector 1 is attached to the window member 10 having a rectangular shape.

First, the belt-shaped directional reflector 1 is let out from the rolled directional reflector 1 (in the state of the so-called stock roll) and is cut in an appropriate size corresponding to the shape of the window member 10 to which the directional reflector 1 is to be attached, thereby obtaining the directional reflector 1 having a rectangular shape. As illustrated in FIG. 17A, the rectangular directional reflector 1 has a pair of opposing long sides Lₐ and a pair of opposing short sides L_{b}. The long sides Lₐ of the rectangular directional reflector 1 are substantially parallel to a ridge l_{c} of the corner cube in the incident surface of the directional reflector 1. In other words, the lengthwise direction D_{L} of the rectangular directional reflector 1 is substantially parallel to the direction of the ridge l_{c} of the corner cube in the incident surface of the directional reflector 1.

Next, one short side L_{b} of the cut directional reflector 1 is aligned with a short side 10a of the rectangular window member 10, which is positioned at an upper end thereof. Next, the rectangular directional reflector 1 is gradually attached to the window member 10 in a direction from the upper end toward the lower end thereof with the attaching layer 6 interposed between them. Finally, the other short side L_{b} of the directional reflector 1 is aligned with a short side 10b of the rectangular window member 10, which is positioned at the lower end thereof. Next, if necessary, the surface of the directional reflector 1 attached to the window member 10 is pressed, for example, to purge out bubbles trapped between the window member 10 and the directional reflector 1. As a result, the rectangular directional reflector 1 is attached to the window member 10 in such a state that the ridge l_{c} of the corner cube in the incident surface of the directional reflector 1 is substantially parallel to a height direction D_{H} of a building, e.g., a high-rise building.

[Attaching Direction of Directional Reflector]

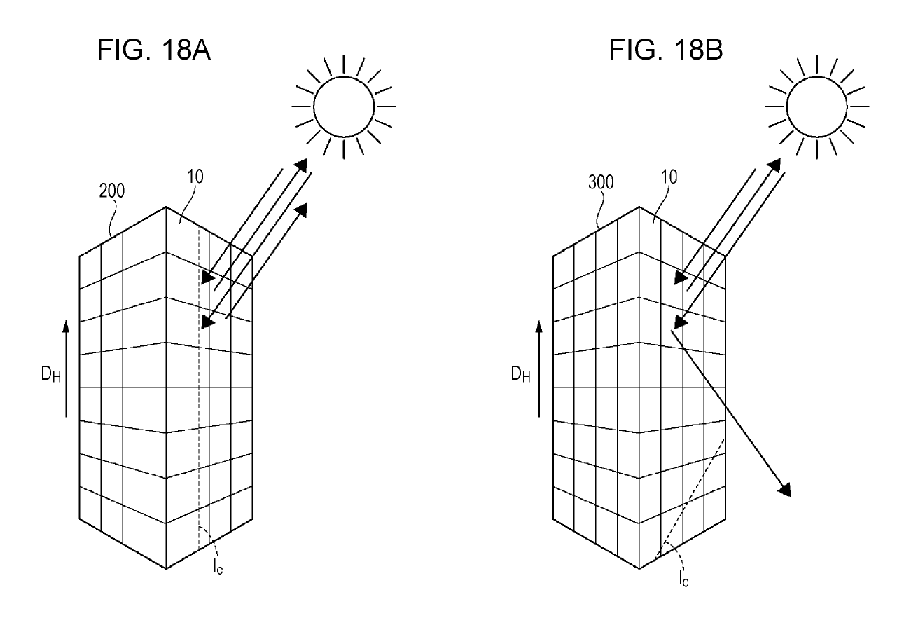

FIGS. 18A and 18B are illustrations to explain the difference in reflection function of the directional reflector 1 depending on the attaching direction.

FIG. 18A illustrates an example of a building 200 in which the directional reflector 1 is attached to the window member 10 such that the ridge l_{c} of the corner cube in the incident surface of the directional reflector 1 is substantially parallel to the height direction D_{H} of the building 200. Stated another way, FIG. 18A illustrates an example in which the directional reflector 1 is attached to the window member 10 in accordance with the above-described method of attaching the directional reflector. When the directional reflector 1 is attached to the window member 10 in such a way, the reflection function of the directional reflector 1 can be effectively developed. Thus, most of light incident on the window member 10 from above can be reflected upwards. Consequently, upward reflectance of the window member 10 can be increased.

FIG. 18B illustrates an example of a building 300 in which the directional reflector 1 is attached to the window member 10 such that the ridge l_{c} of the corner cube in the incident surface of the directional reflector 1 forms an angle of 30° with respect to the height direction D_{H} of the building 300. When the directional reflector 1 is attached to the window member 10 in such a way, the reflection function of the directional reflector 1 is not effectively developed. Thus, a proportion at which light incident on the window member 10 from above is reflected downwards increases. Consequently, upward reflectance of the window member 10 is reduced.

According to the first embodiment, as described above, the direction of the ridge l_{c} of the corner cube in the incident surface of the directional reflector 1 is set substantially parallel to the lengthwise direction D_{L} of the belt-shaped or rectangular directional reflector 1. Therefore, the reflection function of the directional reflector 1 can be effectively developed by attaching the directional reflector 1 to the window member 10 such that the lengthwise direction D_{L} of the belt-shaped directional reflector 1 or the rectangular directional reflector 1 cut from the former is substantially parallel to the height direction D_{H} of the building. Hence, the upward reflectance of the window member 10 to which the directional reflector 1 is attached can be increased.

When the roll-shaped master is used as the master, the directional reflector 1 can be continuously fabricated in the roll-to-roll manner. Accordingly, the directional reflector 1 can be fabricated in the form applicable to a large-size adherend, e.g., the window member. On the other hand, a fusion-extruding method per batch, for example, has a difficulty in fabricating the directional reflector 1 in the form applicable to the large-size adherend, e.g., the window member.

Preferably, the concave-convex shape is seamlessly formed on the cylindrical surface of the roll-shaped master by, e.g., bite machining or laser machining. When the directional reflector 1 is continuously fabricated in the roll-to-roll manner by using that type of roll-shaped master, the concave-convex shape can be seamlessly formed on the first optical layer 4 or the second optical layer 5. Accordingly, the directional reflector 1 can be fabricated in the form applicable to the large-size adherend, e.g., the window member. On the other hand, when the roll-shaped master is fabricated by winding a corner cube master in the form of a flat plate around a roll, a seam is generated in the concave-convex shape on the first optical layer 4 or the second optical layer 5. Hence, it is difficult to fabricate the directional reflector 1 in the form applicable to the large-size adherend, e.g., the window member.

When the roll-shaped master 43 is fabricated by machining the workpiece 100 with the machining method according to the first embodiment, two of the three reflective side surfaces forming one corner cube are curved surfaces, and the remaining one surface is a flat surface. By fabricating the directional reflector (retroreflector) 1 with the use of the roll-shaped master 43 on which that type of corner cubes are formed, the directional reflector 1 superior in an incident angle characteristic of light is obtained. Further, the directional reflector 1 having the belt-like shape free from seams can be obtained.

<Modifications>

Modifications of the foregoing first embodiment will be described below.

[First Modification]

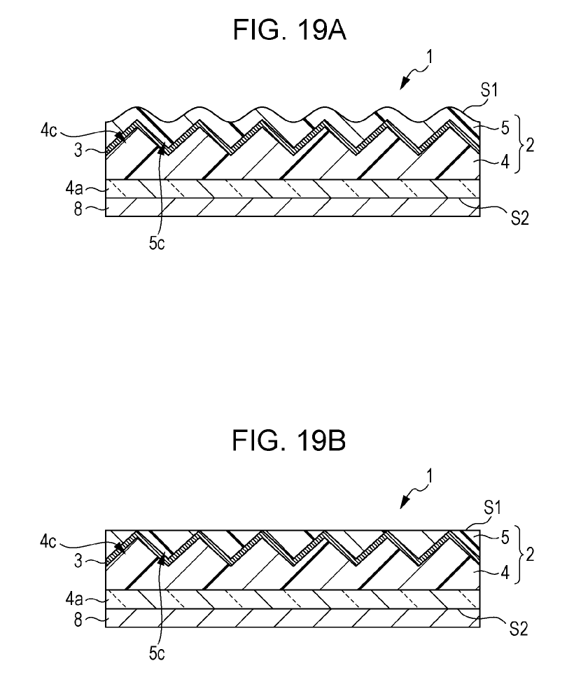

FIG. 19A is a sectional view illustrating a first modification of the first embodiment. As illustrated in FIG. 19A, a directional reflector 1 according to the first modification has an incident surface S1 having a concave-convex shape. The concave-convex shape of the incident surface S1 and the concave-convex shape of the first optical layer 4 are formed, for example, such that both the concave-convex shapes correspond to each other, namely that the positions of tops of convexes and the positions of bottoms of concaves are aligned between the incident surface S1 and the first optical layer 4. The concave-convex shape of the incident surface S1 is preferably gentler than the concave-convex shape of the first optical layer 4.

[Second Modification]

FIG. 19B is a sectional view illustrating a second modification of the first embodiment. As illustrated in FIG. 19B, the directional reflector 1 according to the second modification is formed such that tops of convexes in the concave-convex surface of the first optical layer 4 including the reflective layer 3 formed thereon are positioned substantially at the same height as the incident surface S1 of the first optical layer 4.

### 2. Second Embodiment

[Construction of Directional Reflector]

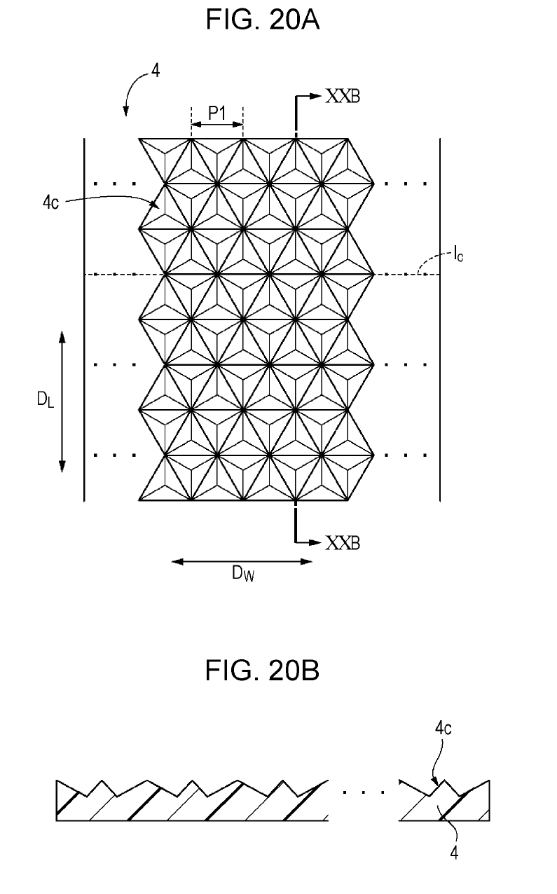

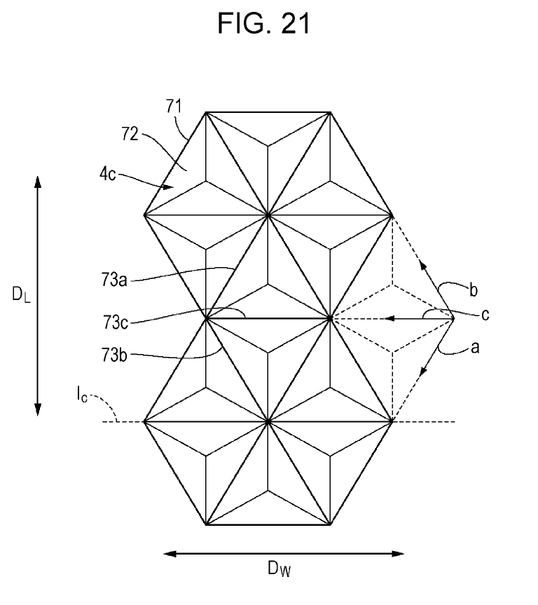

FIG. 20A is a plan view illustrating one example of the shape of a concave-convex surface of a first optical layer, and FIG. 20B is a sectional view of the first optical layer taken along line XXB-XXB in FIG. 20A. FIG. 21 is an enlarged plan view illustrating, in an enlarged scale, part of the concave-convex surface of the first optical layer illustrated in FIG. 20A. A directional reflector 1 according to the second embodiment differs from the directional reflector 1 according to the first embodiment in that, in the concave-convex surface of the first optical layer 4, one ridge direction c of the three ridge directions a, b and c is substantially parallel to a widthwise direction (transverse direction) D_{W} of the directional reflector 1 having a belt-like shape. The widthwise direction D_{W} and the lengthwise direction D_{L} of the belt-shaped directional reflector 1 are orthogonal to each other.

Stated another way, the direction of the ridge l_{c} of the corner cube in the incident surface is substantially parallel to the widthwise direction D_{W} of the belt-shaped directional reflector 1. Herein, the expression “substantially parallel” implies that an angle formed between the direction of the ridge l_{c} of the corner cube in the incident surface and the widthwise direction of the directional reflector 1 is ±10° or smaller, including the case where the formed angle is exactly 0°. The direction of the ridge l_{c} of the corner cube in the incident surface of the directional reflector 1 is substantially parallel to one ridge direction c of the three ridge directions a, b and c in the concave-convex surface of the directional reflector 1.

(Workpiece)

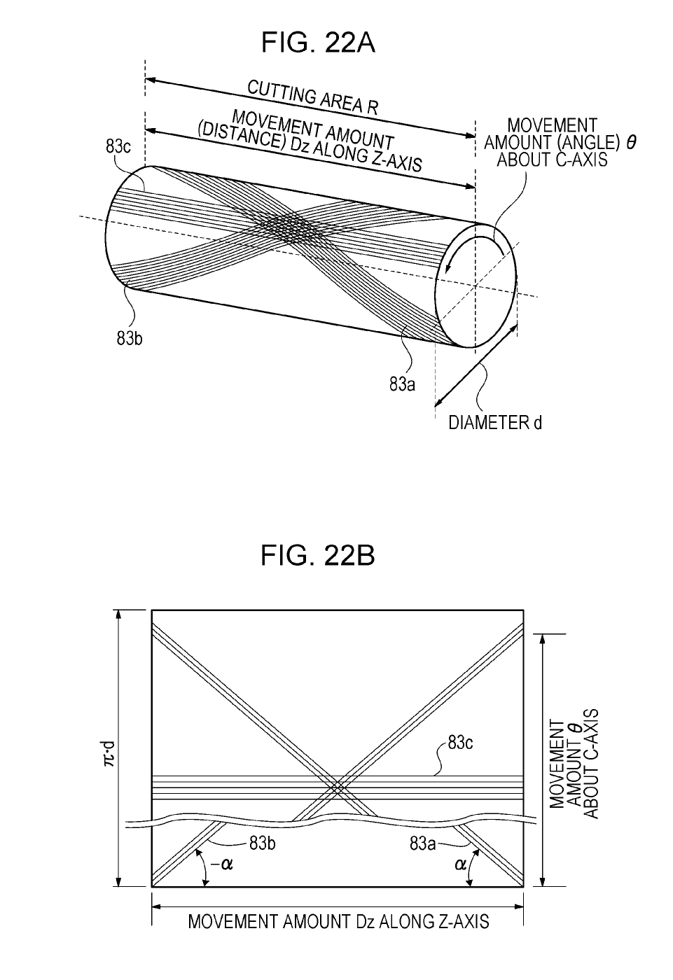

FIG. 22A is a perspective view illustrating an overall appearance of a workpiece, and FIG. 22B is a development view of the workpiece illustrated in FIG. 22A. As illustrated in FIGS. 22A and 22B, the V-shaped groove 83a extending in a direction of the angle α, the V-shaped groove 83b extending in a direction of the angle −α, and the V-shaped groove 83c extending in a direction of an angle β are formed in the workpiece surface. Preferably, the angle α is in the range of 0°<α<90°, the angle −α is in the range of −90°<−α<0°, and the angle β is 0°. The respective angles (α, −α, β) of the three types of V-shaped grooves 83a, 83b and 83c formed in the workpiece surface are more preferably equal to angles (60°, −60°, 0°).

[Method of Machining Workpiece]

First, in a similar manner to that in the first embodiment, a large number of V-shaped grooves 83a and 83b extending in two directions of the angle α (e.g., the angle of 60°) and the angle −α (e.g., the angle of −60°) are formed in the workpiece surface. Next, the bite 96 is returned to the one end of the cutting region R of the workpiece 100, and the tip position of the bite 96 is adjusted such that the V-shaped groove 83c extending in the direction 13 passes an intersect between the V-shaped grooves 83a and 83b extending respectively in the directions of the angle α and the angle −α. Next, the second slide 94 is driven to press the bite 96 against the one end of the cutting region R by a certain force, and the bite 96 is moved toward the other end of the cutting region R. As a result, the V-shaped groove 83c extending in the direction of the angle β (e.g., the angle of 0°) is formed in the workpiece surface. The above-described cutting is repeated while the tip of the bite 96 is moved at a predetermined pitch in the radial direction of the workpiece 100. Consequently, a large number of V-shaped grooves 83c extending in the direction of the angle β are formed in the workpiece surface.

Thus, the objective roll-shaped master 43 is obtained.

[Method of Attaching Directional Reflector]

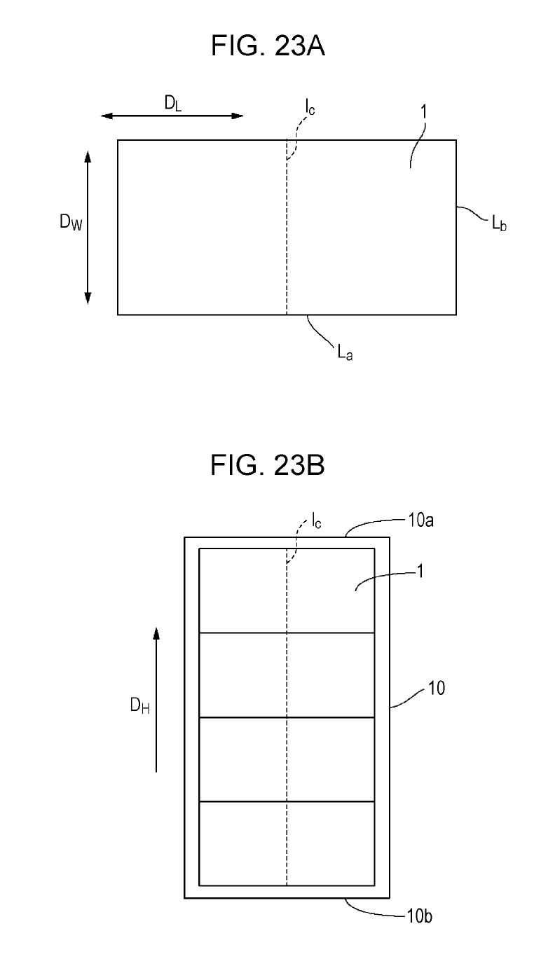

FIGS. 23A and 23B are illustrations to explain one example of a method of attaching the directional reflector according to the second embodiment.

First, the belt-shaped directional reflector 1 is let out from the rolled directional reflector 1 (in the form of the so-called stock roll) and is cut in an appropriate size corresponding to the shape of the window member 10 to which the directional reflector 1 is to be attached, thereby obtaining the directional reflector 1 having a rectangular shape. As illustrated in FIG. 23A, the rectangular directional reflector 1 has a pair of opposing long sides Lₐ and a pair of opposing short sides L_{b}. The short sides L_{b} of the rectangular directional reflector 1 are substantially parallel to the ridge l_{c} of the corner cube in the incident surface of the directional reflector 1. In other words, the widthwise direction D_{W} of the rectangular directional reflector 1 is substantially parallel to the ridge l_{c} of the corner cube in the incident surface of the directional reflector 1.

Next, one long side Lₐ of the cut directional reflector 1 is aligned with a short side 10a of a rectangular window member 10, which is positioned at an upper end thereof. Next, the rectangular directional reflector 1 is gradually attached to the window member 10 in a direction from the upper end toward the lower end thereof with the attaching layer 6 interposed between them. Next, if necessary, the surface of the directional reflector 1 attached to the window member 10 is pressed, for example, to purge out bubbles trapped between the window member 10 and the directional reflector 1. Next, work of attaching the new directional reflector 1 is repeated to attach it adjacent to the directional reflector 1, which has been attached to the window member 10 as described above. As a result, the rectangular directional reflectors 1 are attached to the window member 10 in such a state that the ridge l_{c} of the corner cube in the incident surface of each directional reflector 1 is substantially parallel to the height direction D_{H} of the building, e.g., the high-rise building.

### 3. Third Embodiment

A third embodiment differs from the first embodiment in that the light of the specific wavelength is directionally reflected, while the light of wavelengths other than the specific wavelength is scattered. A directional reflector 1 according to the third embodiment includes a light scatterer for scattering the incident light. The light scatterer is disposed, for example, in at least one of positions on the surface of the optical layer 2, inside the optical layer 2, and between the reflective layer 3 and the optical layer 2. Preferably, the light scatterer is disposed in at least one of positions between the reflective layer 3 and the first optical layer 4, inside the first optical layer 4, and on the surface of the first optical layer 4. When the directional reflector 1 is attached to a support such as the window member, it can be attached to either the indoor side or the outdoor side of the support. When the directional reflector 1 is attached to the outdoor side, the light scatterer for scattering the light of wavelengths other than the specific wavelength is preferably disposed only between the reflective layer 3 and the support such as the window member. The reason is that if the light scatterer is present between the reflective layer 3 and the incident surface, the directional reflection characteristic is lost when the directional reflector 1 is attached to the support such as the window member. Also, when the directional reflector 1 is attached to the indoor side, the light scatterer is preferably disposed between the reflective layer 3 and the emergent surface on the side opposite to the attached surface of the directional reflector 1.

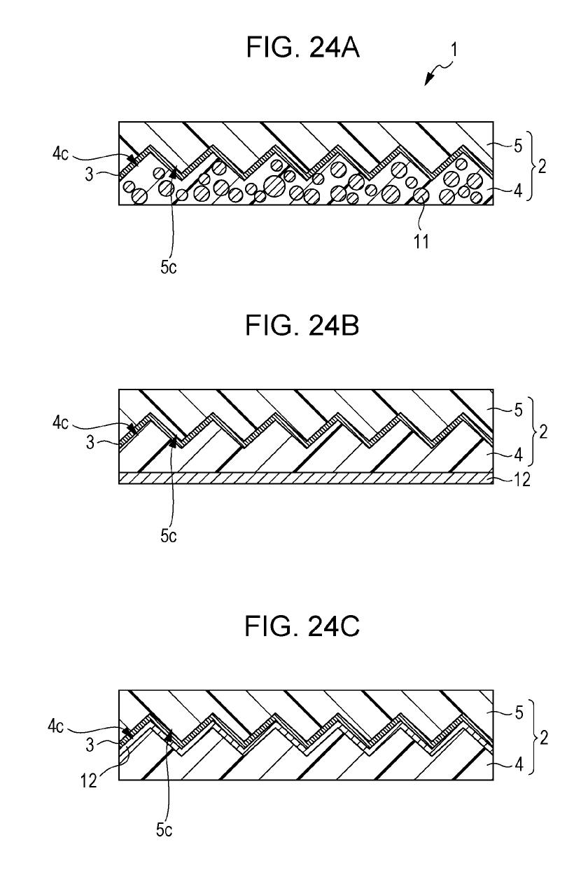

FIG. 24A is a sectional view illustrating a first example of construction of the directional reflector according to the third embodiment. As illustrated in FIG. 24A, the first optical layer 4 includes a resin and fine particles 11. The fine particles 11 have a refractive index differing from that of the resin, which is a main component material of the first optical layer 4. For example, at least one kind of organic fine particles and inorganic fine particles can be used as the fine particles 11. The fine particles 11 may be hollow fine particles. Examples of the fine particles 11 include inorganic fine particles made of, e.g., silica or alumina, and organic fine particles made of, e.g., styrene, acryl, or a copolymer of the formers. However, silica fine particles are particularly preferable.

FIG. 24B is a sectional view illustrating a second example of construction of the directional reflector according to the third embodiment. As illustrated in FIG. 24B, the directional reflector 1 further includes a light diffusion layer 12 on the surface of the first optical layer 4. The light diffusion layer 12 includes, for example, a resin and fine particles. The same materials as those used in the above-described first example can be used as the fine particles.

FIG. 24C is a sectional view illustrating a third example of construction of the directional reflector according to the third embodiment. As illustrated in FIG. 24C, the directional reflector 1 further includes a light diffusion layer 12 between the reflective layer 3 and the first optical layer 4. The light diffusion layer 12 includes, for example, a resin and fine particles. The same materials as those used in the above-described first example can be used as the fine particles.

According to the third embodiment, it is possible to directionally reflect the light in the specific wavelength band, e.g., an infrared ray, and to scatter the light in wavelength bands other than the specific wavelength band, e.g., visible light. Hence, a visually attractive design can be given to the directional reflector 1 by making the directional reflector 1 clouded.

### 4. Fourth Embodiment

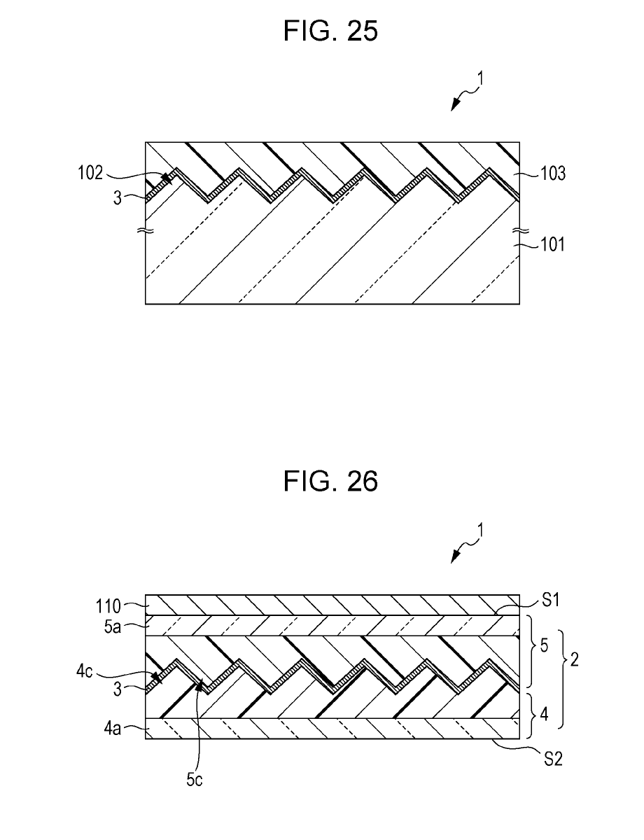

FIG. 25 is a sectional view illustrating one example of construction of a directional reflector according to a fourth embodiment. The same components in the fourth embodiment as those in the first embodiment are denoted by the same reference symbols and descriptions of those components are omitted. The fourth embodiment differs from the first embodiment in that the reflective layer 3 is directly formed on a window member 101.

The window member 101 has a rectangular shape including a pair of opposing long sides and a pair of opposing short sides. The window member 101 is disposed on, e.g., a wall surface of a building in such a state that the long sides of the window member 101 are substantially parallel to the height direction of the building. Further, the direction of the ridge l_{c} of the corner cube in the incident surface of the directional reflector 1 is substantially parallel to the lengthwise direction of the rectangular window member 101.

The window member 101 has a plurality of structures 102 formed on one principal surface thereof. The reflective layer 3 and an optical layer 103 are successively formed on the one principal surface on which the plural structures 102 are formed. Each of the structures 102 may have the same shape as that of the structure 4c in the first embodiment. The optical layer 103 serves to not only improve the transmission image clarity and the total light transmittance, but also protect the reflective layer 3. The optical layer 103 is formed, for example, by curing a resin that contains, as a main component, a thermosetting resin or an ionizing-ray curable resin.

The directional reflector 1 according to the fourth embodiment can also provide similar advantages to those obtained with the first embodiment.

### 5. Fifth Embodiment

FIG. 26 is a sectional view illustrating one example of construction of a directional reflector according to a fifth embodiment. The fifth embodiment differs from the first embodiment in further including a self-cleaning effect layer 110, which develops a cleaning effect in itself, on an exposed surface of the directional reflector 1 on the side opposite to one of the incident surface S1 and the emergent surface S2 thereof, which is attached to the adherend. The self-cleaning effect layer 110 includes, for example, a photocatalyst. For example, TiO₂ can be used as the photocatalyst.

As described above, the directional reflector 1 is featured in being semitransparent to the incident light. When the directional reflector 1 is used outdoors or in a dirty room, for example, light is scattered due to dirt and dust adhering to the surface of the directional reflector 1, thus causing transmissivity and reflectivity to be lost. Therefore, the surface of the directional reflector 1 is preferably optically transparent at all times. In other words, it is preferable that the surface of the directional reflector 1 is superior in the water-repellent or hydrophilic property and it can automatically develop the self-cleaning effect.

According to the fifth embodiment, since the directional reflector 1 includes the self-cleaning effect layer, the water-repellent or hydrophilic property, etc. can be given to the incident surface. Hence, it is possible to suppress dirt and dust from adhering to the incident surface and to retard a reduction of the directional reflection characteristic.

### 6. Sixth Embodiment

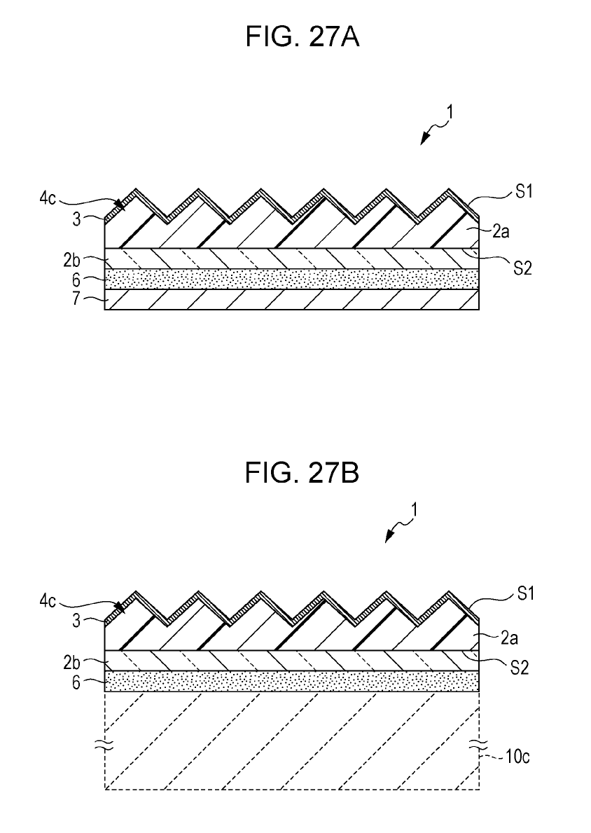

FIG. 27A is a sectional view illustrating one example of construction of a directional reflector according to a sixth embodiment. The same components in the sixth embodiment as those in the first embodiment are denoted by the same reference symbols and descriptions of those components are omitted. As illustrated in FIG. 27A, a directional reflector 1 according to the sixth embodiment differs from that according to the first embodiment in that a concave-convex surface of an optical layer 2a is not covered with or enclosed in a resin material, for example, and the reflective layer 3 formed on the concave-convex surface of the optical layer 2a is exposed. The directional reflector 1 has an incident surface S1 having a concave-convex shape on which light, e.g., sunlight, is incident, and an emergent surface S2 from which, of the light incident on the incident surface S1, light having passed through the directional reflector 1 emerges.

The directional reflector 1 may further include, if necessary, a base element 2b on the emergent surface S2 of the optical layer 2a. In addition, the directional reflector 1 may include, if necessary, an attaching layer 6 and a peeling-off layer 7 on the emergent surface S2 of the optical layer 2a or on the base element 2b. The optical layer 2a and the base element 2b can be made of the same materials as those usable for the first optical layer 4 and the base element 4a in the above-described first embodiment.

FIG. 27B is a sectional view illustrating an example in which the directional reflector according to the sixth embodiment is attached to an adherend. As illustrated in FIG. 27B, the emergent surface S2 of the directional reflector 1 is attached to an adherend 10c with, e.g., the attaching layer 6 interposed between them. The adherend 10c is preferably a window member, a blind, a rolling screen, a pleated screen, etc.

According to the sixth embodiment, since the concave-convex surface of the optical layer 2a on which the reflective layer 3 is formed is employed as the incident surface S1, part of the incident light is scattered by the incident surface S1, while part of the light having been not scattered passes through the directional reflector 1. As a result, it is possible to provide the directional reflector 1 which allows a viewing person to feel brightness of light with the incident light, but which is not transparent. Because of having such a characteristic, the directional reflector 1 according to the sixth embodiment can be suitably applied to interior members, exterior members, and solar shading members in the case where privacy is to be protected. More practical examples of the suitable applications include a window member, a blind, a rolling screen, a pleated screen, etc.

### 7. Seventh Embodiment

While the first embodiment has been described, by way of example, in connection with the case of applying the present invention to the window member or the like, embodiments can be further applied to interior members and exterior members other than the window member. More specifically, embodiments are applicable to not only stationary interior and exterior members which are fixedly disposed, such as walls and roofs, but also a device which can take sunlight into, e.g., an indoor space by moving the interior or exterior member so as to adjust a transmission amount and/or a reflection amount of the sunlight depending on changes in intensity of the sunlight, which are caused with changing of seasons and time. A seventh embodiment is described in connection with, as one example of such a device, a solar shading device (blind device) which can adjust, by changing an angle of a solar shading member group made up of plural solar shading members, an extent at which the solar shading member group shields the incident light.

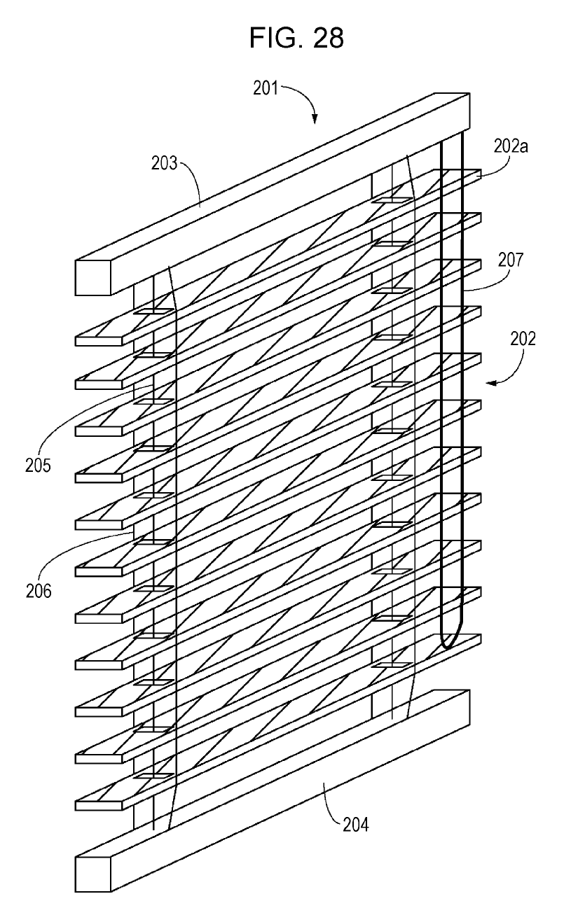

FIG. 28 is a perspective view illustrating one example of construction of the blind device according to the seventh embodiment. As illustrated in FIG. 28, the blind device as one example of the solar shading device includes a head box 203, a slat group (solar shading member group) 202 made up of plural slats (blades) 202a, and a bottom rail 204. The head box 203 is disposed above the slat group 202 made up of the plural slats 202a. Ladder chords 206 and rise-and-fall chords 205 are extended downwards from the head box 203, and the bottom rail 204 is suspended at lower ends of those chords. The slats 202a serving as the solar shading members are each formed in a slender rectangular shape and are supported by the ladder chords 206, which are extended downwards from the head box 203, at predetermined intervals in a suspended state. Further, the head box 203 includes an operating member (not shown), such as a rod, for adjusting an angle of the slat group 202 made up of the plural slats 202a.

The head box 203 serves as a driving unit for adjusting the intensity of light taken into an indoor space, for example, by rotating the slat group 202 made up of the plural slats 202a in accordance with operation of the operating member, such as the rod. The head box 203 also serves as a driving unit (raising and lowering unit) for raising and lowering the slat group 202, as appropriate, in accordance with an operating member, e.g., a rise-and-fall operating chord 207.

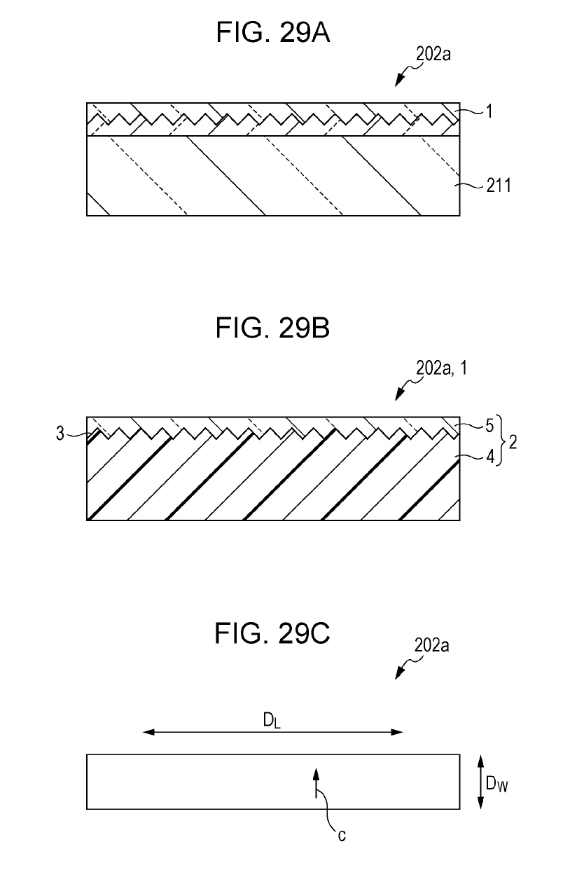

FIG. 29A is a sectional view illustrating a first example of construction of the slat. As illustrated in FIG. 29A, the slat 202a includes a base element 211 and a directional reflector 1. The directional reflector 1 is preferably disposed on one of two principal surfaces of the base element 211, the one principal surface being positioned on the side including an incident surface on which outside light is incident when the slat group 202 is in a closed state (e.g., on the side facing the window member). The directional reflector 1 and the base element 211 are attached to each other with, for example, an attaching layer interposed between them.

The base element 211 can be formed in the shape of, e.g., a sheet, a film, or a plate. The base element 211 can be made of, e.g., glass, resin, paper, or cloth. In consideration of the case of taking visible light into a predetermined indoor space, for example, a resin having transparency is preferably used as the material of the base element 211. As the glass, the resin, the paper, or the cloth, the same materials as those generally used in ordinary rolling screens can be used. As the directional reflector 1, one type or two or more types of the above-described directional reflectors 1 according to the first to sixth embodiments can be used alone or in a combined manner.

FIG. 29B is a sectional view illustrating a second example of construction of the slat. In the second example, as illustrated in FIG. 29B, the directional reflector 1 is used as the slat 202a. The directional reflector 1 preferably has such a level of rigidity that the directional reflector 1 can be supported by the ladder chords 206 and can maintain its shape in a supported state.

FIG. 29C is a plan view of the slat, looking from the side including the incident surface on which outside light is incident when the slat group is in the closed state. As illustrated in FIG. 29C, a widthwise direction D_{W} of the slat 202a is substantially aligned with the ridge direction c of the corner cube. The reason is in that such an arrangement increases efficiency of upward reflection.

### 8. Eighth Embodiment

An eighth embodiment will be described below in connection with a rolling screen device as one example of a solar shading device capable of adjusting an extent at which a solar shading member shields the incident light, by taking up or letting out the solar shading member.

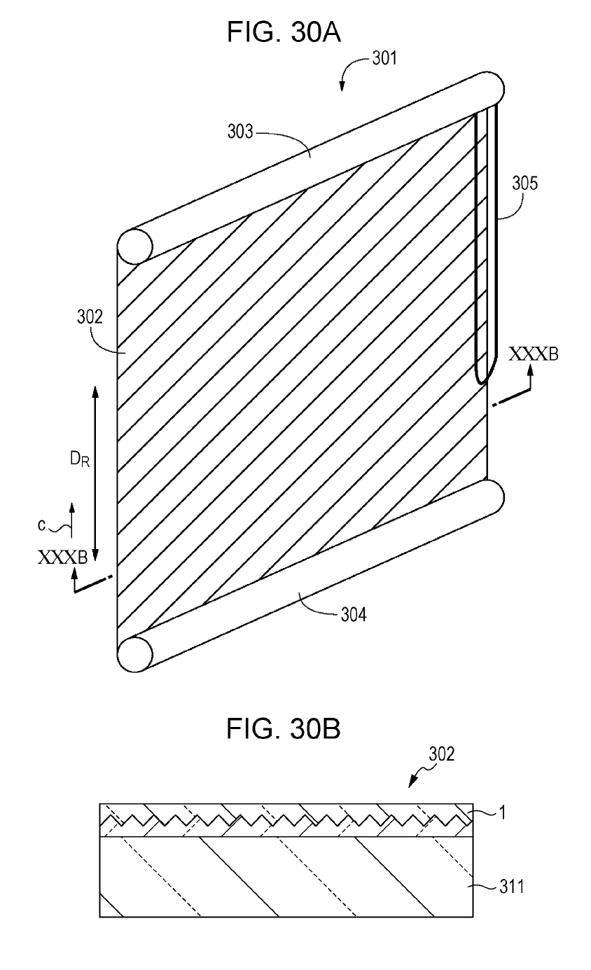

FIG. 30A is a perspective view illustrating one example of construction of a rolling screen device according to the eighth embodiment. As illustrated in FIG. 30A, a rolling screen device 301 as one example of the solar shading device includes a screen 302, a head box 303, and a core member 304. The head box 303 can raise and fall the screen 302 by operating an operating member that is in the form of a chain 305, for example. The head box 303 includes therein a winding shaft for taking up and letting out the screen 302, and one end of the screen 302 is coupled to the winding shaft. Further, the core member 304 is coupled to the other end of the screen 302. Preferably, the screen 302 has flexibility. The shape of the screen 302 is not limited to particular one and is preferably selected depending on the shape of, e.g., the window member to which the rolling screen device 301 is applied. For example, a rectangular shape is selected.

As illustrated in FIG. 30A, a taking-up or letting-out direction D_{R} of the screen 302 is substantially aligned with the ridge direction c of the corner cube. The reason is in that such an arrangement increases efficiency of upward reflection.

FIG. 30B is a sectional view, taken along line XXXB-XXXB in FIG. 30A, illustrating one example of construction of the screen 302. As illustrated in FIG. 30B, the screen 302 includes a base element 311 and a directional reflector 1, and it preferably has flexibility. The directional reflector 1 is preferably disposed on one of two principal surfaces of the base element 311, the one principal surface being positioned on the side including an incident surface on which outside light is incident (e.g., on the side facing the window member). The directional reflector 1 and the base element 311 are attached to each other with, for example, an attaching layer interposed between them. Note that the construction of the screen 302 is not limited to the illustrated example and the directional reflector 1 may be used itself as the screen 302.

The base element 311 can be formed in the shape of, e.g., a sheet, a film, or a plate. The base element 311 can be made of, e.g., glass, resin, paper, or cloth. In consideration of the case of taking visible light into a predetermined indoor space, for example, a resin having transparency is preferably used as the material of the base element 311. As the glass, the resin, the paper, or the cloth, the same materials as those generally used in ordinary rolling screens can be used. As the directional reflector 1, one type or two or more types of the above-described directional reflectors 1 according to the first to sixth embodiments can be used alone or in a combined manner.

### 9. Ninth Embodiment

A ninth embodiment will be described below in connection with an application example in which a fitting (interior or exterior member) includes a lighting portion provided with an optical body having a directional reflection property.

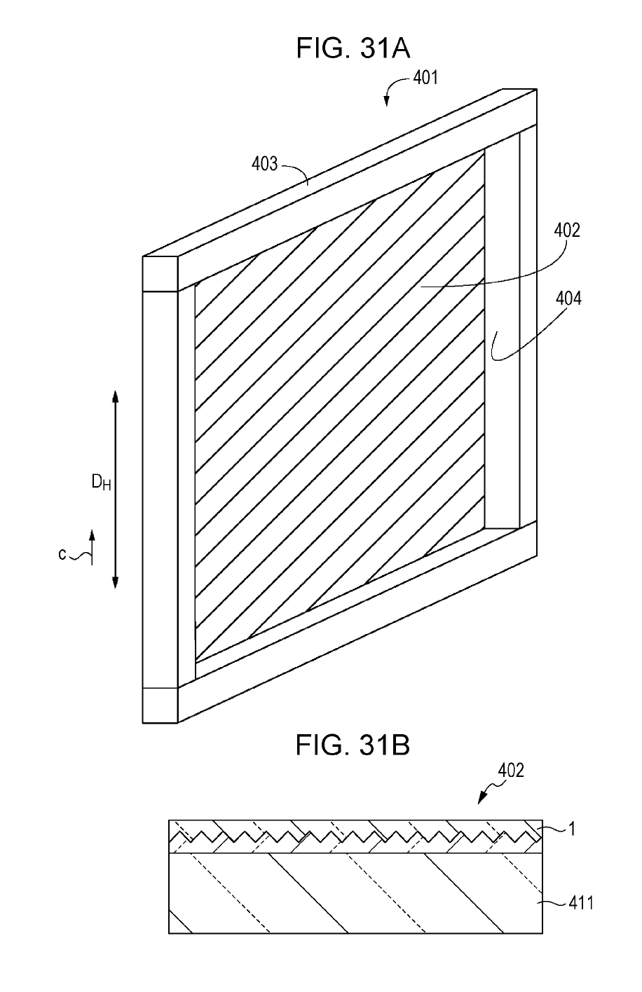

FIG. 31A is a perspective view illustrating one example of construction of the fitting according to the ninth embodiment. As illustrated in FIG. 31A, a fitting 401 includes a lighting portion 404 provided with an optical body 402. More specifically, the fitting 401 includes the optical body 402 and a frame member 403 disposed at a peripheral edge of the optical body 402. The optical body 402 is fixedly held by the frame member 403 in such a way that, if necessary, the optical body 402 can be removed by disassembling the frame member 403. One example of the fitting 401 usable here is a shoji (i.e., a paper-made and/or glass-fitted sliding door), but applications are not limited to such an example. Embodiments can be applied to various types of fittings provided with lighting portions.

As illustrated in FIG. 31A, a height direction D_{H} of the optical body 402 is substantially aligned with the ridge direction c of the corner cube. The reason is in that such an arrangement increases efficiency of upward reflection.

FIG. 31B is a sectional view illustrating one example of construction of the optical body 402. As illustrated in FIG. 31B, the optical body 402 includes a base element 411 and a directional reflector 1. The directional reflector 1 is preferably disposed on one of two principal surfaces of the base element 411, the one principal surface being positioned on the side including an incident surface on which outside light is incident (e.g., on the side facing outwards). The directional reflector 1 and the base element 411 are attached to each other with, for example, an attaching layer interposed between them. Note that the construction of the optical body 402 is not limited to the illustrated example and the directional reflector 1 may be used itself as the optical body 402.

The base element 411 can be formed of, e.g., a sheet, a film, or a plate each having flexibility. The base element 411 can be made of, e.g., glass, resin, paper, or cloth. In consideration of the case of taking visible light into a predetermined indoor space, for example, a resin having transparency is preferably used as the material of the base element 311. As the glass, the resin, the paper, or the cloth, the same materials as those generally used in optical bodies in ordinary fittings can be used. As the directional reflector 1, one type or two or more types of the above-described directional reflectors 1 according to the first to sixth embodiments can be used alone or in a combined manner.

### 10. Tenth Embodiment

[Machining Apparatus]

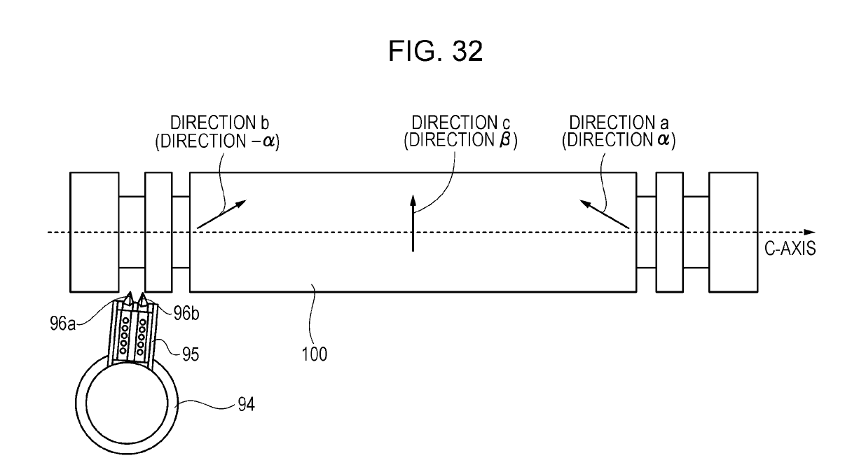

FIG. 32 is a schematic view illustrating one example of construction of a machining apparatus according to a tenth embodiment. As illustrated in FIG. 32, the machining apparatus according to the tenth embodiment differs from the machining apparatus according to the first embodiment in that the bite support 95 can support two bites 96a and 96b. The bite 96a is used to form the V-shaped groove extending in the direction of the angle α, and the bite 96b is used to form the V-shaped groove extending in the direction of the angle −α. Further, one of the bites 96a and 96b can also be used to form the V-shaped groove extending in the direction of the angle β by appropriately adjusting an angle at which the bite is pressed against the workpiece surface.

[Method of Machining Workpiece]

One example of a method of machining a workpiece by the machining apparatus thus constructed will be described below. First, the V-shaped groove extending in the direction of the angle α (e.g., the angle of 30°) is formed from the one end of the cutting region R of the workpiece 100 in a similar manner to that in the first embodiment except for using one 96a of the two bites 96a and 96b. At that time, the workpiece 100 is rotated counterclockwise, for example.

Next, the second slide 94 is driven to press the bite 96b against the other end of the cutting region R by a certain force, and the workpiece 100 is rotated to start the machining of the V-shaped groove. More specifically, at that time, the workpiece 100 is rotated in the same direction as that when the V-shaped groove extending in the direction α, e.g., counterclockwise. Next, while continuing the rotation of the workpiece 100, the first slide 93 is driven to move the bite 96b in the Z-axis direction. At that time, a rotating speed of the workpiece 100 and a moving speed of the first slide 93 are synchronized with each other such that the cut V-shaped groove forms the angle −α (e.g., the angle of −30°) with respect to the rotation axis (C-axis) of the workpiece 100. As a result, the V-shaped groove extending in the direction of the angle −α is formed with the bite 96b drawing a predetermined locus on the workpiece surface. Next, when the bite 96b reaches the one end of the cutting region R, the second slide 94 is driven to move the bite 96b away from the workpiece surface, thereby stopping the machining of the V-shaped groove.

Next, the above-described cuttings of the V-shaped grooves extending in the directions of the angle α and the angle −α are repeated while the tip positions of the bites 96a and 96b are shifted by a predetermined pitch in the radial direction of the workpiece 100 at both the ends of the cutting region R. As a result, many V-shaped grooves extending in two directions of the angle α and the angle −α are formed in the workpiece surface.

Next, the tip position of one of the bites 96a and 96b is adjusted and is pressed against the workpiece surface to repeatedly form the V-shaped groove extending in the direction of the angle β in a similar manner to that described in the first embodiment.

Thus, the objective roll-shaped master 43 is obtained.

With the machining method according to the tenth embodiment, since the V-shaped grooves extending in two directions of the angle α and the angle −α can be formed while the bites 96a and 96b are reciprocated, machining efficiency of the workpiece can be increased.

### EXAMPLES

The embodiments will be described in detail below in connection with TEST EXAMPLES, but embodiments are not limited to the following TEST EXAMPLES.

### Test Example 1

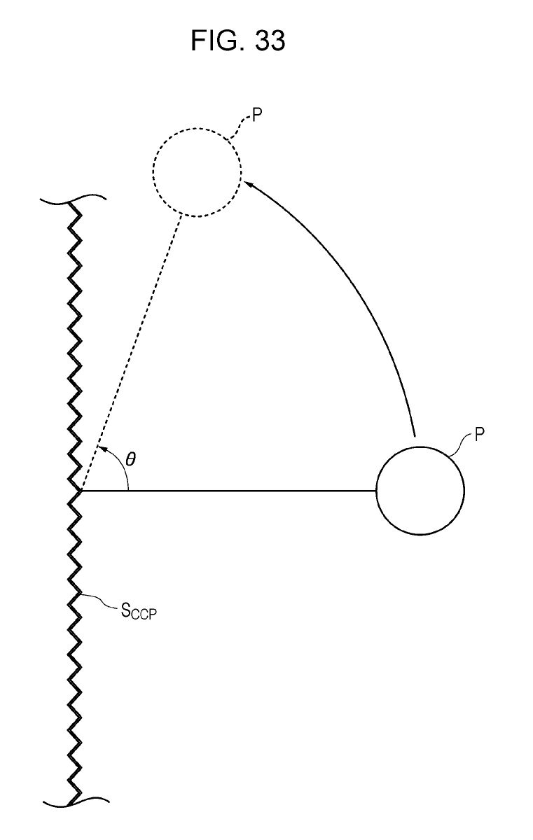

FIG. 33 is an illustration to explain simulation conditions in TEST EXAMPLE 1.

The following simulation was performed to measure upward reflectance by using the illumination design analysis software Light Tools made by ORA (Optical Research Associates).

First, a directional reflective surface S_{CCP} including a corner cube pattern formed in the close-packed state was set.

Setting conditions of the directional reflective surface S_{CCP} were as follows:

Pitch of corner cubes: 100 μm

Apex angle of corner cube: 90°

Next, an imaginary sunlight source (color temperature of 6500K) was set as a light source P, and light was illuminated to be incident on the directional reflective surface S_{CCP} from a direction of the incident angle (θ, φ)=(0°, 0°). The angle θ was gradually increased in units of 10° within the range of the incident angle (θ, φ)=(0°, 0°) to (70°, 0°).

The upward reflectance is defined by the following formula (1):

Upward reflectance Rᵤₚ=[(total power of light reflected in upward direction)/(total power of incident light)]×100 (1)

where

power of incident light=(power of light reflected in upward direction)+(power of light reflected in downward direction),

upward direction: reflection angle (θ, φ)=(θ, 270°) to (θ, 90°),

downward direction: reflection angle (θ, φ)=(θ, 90°) to (θ, 270°),

directions of φ=90° and 270° being included in the upward direction, and incident angle θ=0°≦θ≦90°

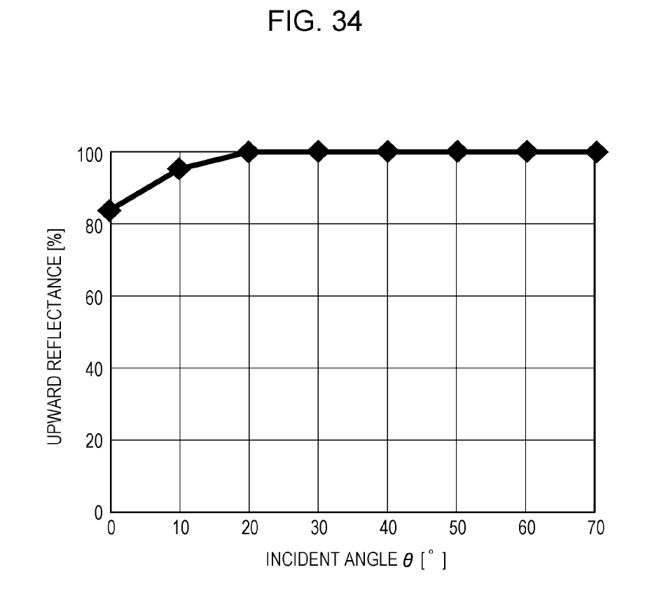

FIG. 34 is a graph plotting the upward reflectance obtained with the above-described simulation. In the graph of FIG. 34, the horizontal axis represents the incident angle θ of light, and the vertical axis represents the upward reflectance.

As seen from FIG. 34, the upward reflectance tends to change as described below with an increase of the incident angle. First, in the case of the incident angle θ=0°, i.e., when the light is perpendicularly incident on the directional reflective surface S_{CCP}, the upward reflectance is about 80%. When the incident angle is gradually increased and the incident angle θ=20° is reached, the upward reflectance becomes 100%. Further, when the incident angle θ is 20° or larger, the upward reflectance is maintained at 100%.

### Test Example 2

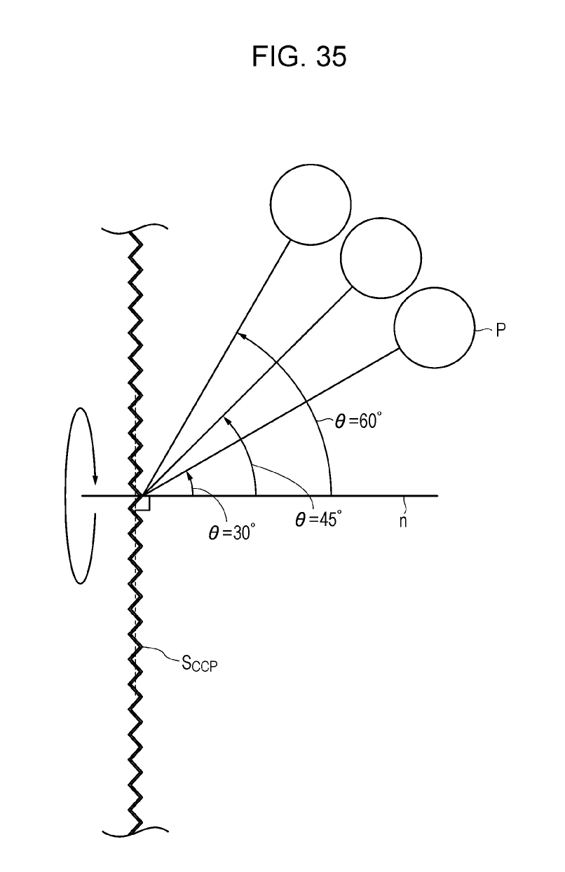

FIG. 35 is an illustration to explain simulation conditions in TEST EXAMPLE 2.

The following simulation was performed to measure upward reflectance by using the illumination design analysis software Light Tools made by ORA (Optical Research Associates).

First, a directional reflective surface S_{CCP} including a corner cube pattern formed in the close-packed state was set.

Setting conditions of the directional reflective surface S_{CCP} were as follows:

Pitch of corner cubes: 100 μm

Apex angle of corner cube: 90°

Next, an imaginary sunlight source (color temperature of 6500K) was set as a light source P. The upward reflectance was measured by illuminating light to be incident on the directional reflective surface S_{CCP} from a direction of the incident angle (θ, φ)=(30°, 0°), and by rotating the directional reflective surface S_{CCP} clockwise. The directional reflective surface S_{CCP} was rotated with a rotation axis set to a perpendicular line n relative to the directional reflective surface S_{CCP}. The upward reflectance is defined by the above-described formula (1) as in TEST EXAMPLE 1.

### Test Example 3

The upward reflectance was measured by setting all the conditions to be the same as those in TEST EXAMPLE 2 except that the incident angle (θ, φ)=(45°, 0°) was set.

### Test Example 4

The upward reflectance was measured by setting all the conditions to be the same as those in TEST EXAMPLE 2 except that the incident angle (θ, φ)=(60°, 0°) was set.

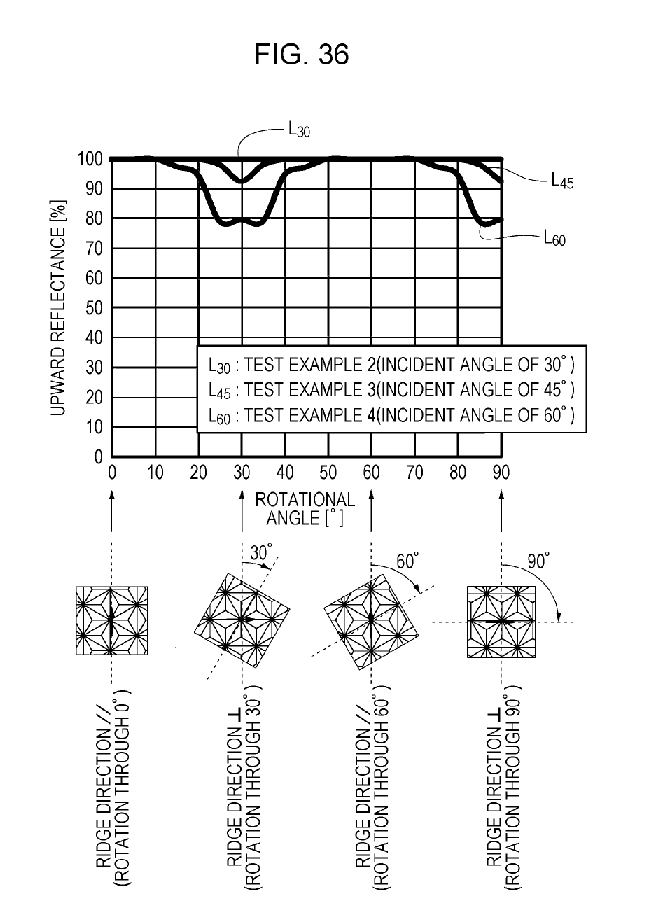

FIG. 36 is a graph plotting the upward reflectance obtained with the above-described simulation. As seen from FIG. 36, the upward reflectance tends to change as described below with the rotation of the directional reflector 1.

First, when the rotational angle α is 0° and the groove direction of the directional reflective surface S_{CCP} is parallel to the direction φ of the incident angle (θ, φ), the upward reflectance is 100% at any of the incident angles θ of 30°, 45° and 60°. Such a result indicates that the incident light incoming from above is returned in the upward direction at any incident angle θ.

Next, when the directional reflector 1 is rotated clockwise, the upward reflectance gradually decreases with an increase of the rotational angle. When the rotational angle reaches 30°, the groove direction of the directional reflective surface S_{CCP} is perpendicular to the direction φ of the incident angle (θ, φ) and the upward reflectance takes an almost minimum value. More specifically, the upward reflectance is reduced about 7% at the incident angle θ=45° and about 20% at the incident angle θ=60°. Such a result indicates that, at the incident angle θ=45°, about 93% of the incident light is directionally reflected upwards, but about 7% of the incident light is reflected downwards without being directionally reflected. Also, such a result indicates that, at the incident angle θ=60°, about 80% of the incident light is directionally reflected upwards, but about 20% of the incident light is reflected downwards without being directionally reflected.

When the directional reflective surface S_{CCP} is further continuously rotated, the upward reflectance gradually increases. When the rotational angle reaches 60°, the groove direction of the directional reflective surface S_{CCP} becomes parallel to the direction φ of the incident angle (θ, φ) and the upward reflectance takes 100% again at any of the incident angles θ of 30°, 45° and 60°. When the directional reflective surface S_{CCP} is further rotated, the upward reflectance cyclically repeats a similar tendency to that in the above-described process when the rotational angle is changed from 0 to 60°.

It is thus understood that the reflection function of the directional reflective surface S_{CCP} can be effectively developed when the groove direction of the directional reflective surface S_{CCP} is substantially parallel to the direction φ of the incident angle (θ, φ).

### Example 1

First, a roll-shaped workpiece 100 having the following parameters was prepared:

Cutting region R: 1000 mm

Diameter d: 250 mm

Outer circumference: π×250 mm=785.398 mm

Next, the prepared workpiece was mounted to the machining apparatus illustrated in FIG. 8. Next, after aligning a bite 96 having a tip opening angle of 70° 32′ with one end of the cutting region R, a V-shaped groove extending in a direction of an angle 30° with respect to the C-axis of the workpiece was formed by setting a rotating speed of the workpiece and a moving speed of the bite to be synchronized with each other. The step of forming the V-shaped groove extending in the direction of the angle 30° was repeated while the tip position of the bite was shifted at a pitch of 100 μm in the radial direction of the roll-shaped workpiece.

Next, many V-shaped grooves extending in a direction of an angle −30° were formed in the workpiece surface in a similar manner to that in the above step of forming the V-shaped groove extending in the direction of the angle 30° except for rotating the workpiece 100 in a reversed direction. As a result, many V-shaped grooves extending in two directions of the angle 30° and the angle −30° were formed.

Next, after adjusting the bite position, cutting of a V-shaped groove was restarted by pressing the bite 96 against the one end of the cutting region R by a certain force and rotating the workpiece 100. At that time, the first slide 93 was held at the same position on the Z-axis while the rotation of the workpiece 100 was continued. As a result, a V-shaped groove extending in a direction of an angle 90° (i.e., in the radial direction) with respect to the C-axis of the workpiece was formed in the workpiece surface by the bite passing intersects between the V-shaped grooves extending in the two directions. Many V-shaped grooves each extending in the direction of the angle β were formed in the workpiece surface by repeating the above-described step of cutting the V-shaped groove extending in the direction of the angle 90° from the one end toward the other end of the cutting region R while the tip position of the bite 96 was shifted at a predetermined pitch. In such a manner, a corner cube pattern was formed on the workpiece surface.

Thus, an objective roll-shaped master was obtained.

Next, the corner cube pattern of the roll-shaped master fabricated as described above was transferred to a PET sheet that was formed by fusion extrusion. As a result, the first optical layer including the corner cube pattern formed in one principal surface thereof was obtained.

Next, an alternate multilayer film made up of a niobium pentoxide film and a silver layer was formed by a vacuum sputtering process on the one principal surface of the first optical layer including the corner cube pattern formed thereon. Next, an acryl-based ultraviolet curable resin composition was coated on the alternate multilayer film. After purging out bubbles, a PET film was placed on the ultraviolet curable resin composition and the ultraviolet curable resin composition was irradiated with UV light, whereby the second optical layer was formed on the alternate multilayer film. Thus, an objective optical film was obtained.

(Evaluation of Upward Reflectance)

The upward reflectance is defined by the following formula (1):

Upward reflectance Rᵤₚ=[(total power of light reflected in upward direction)/(total power of incident light)]×100 (1)

where

power of incident light=(power of light reflected in upward direction)+(power of light reflected in downward direction),

upward direction: reflection angle (θ, φ)=(θ, 270°) to (θ, 90°),

downward direction: reflection angle (θ, φ)=(θ, 90°) to (θ, 270°),

directions of φ=90° and 270° being included in the upward direction, and incident angle θ=0 °≦θ≦90°

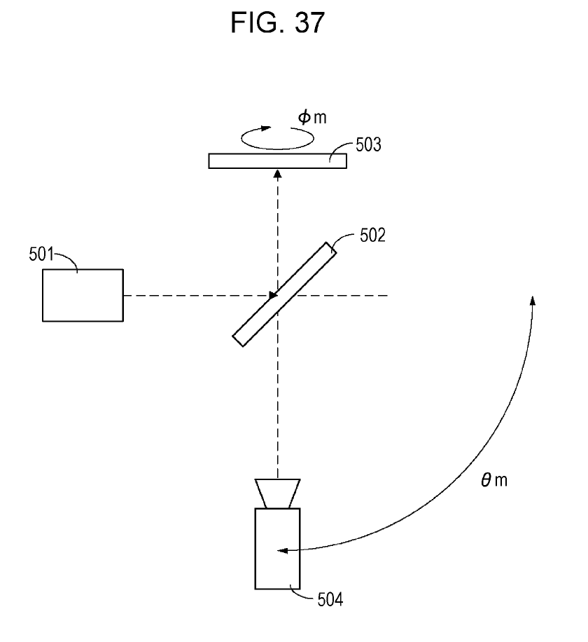

The upward reflectance can be measured by a method of, as illustrated in FIG. 37, using a halogen light source 501 collimated with parallelism of 0.5° or less, irradiating a sample 503 with incident light after being reflected by a half mirror 502, and detecting light reflected from the sample 503 through a monochromator 504. The power of light reflected in the upward direction and the power of light reflected in the downward direction can be measured by arranging the sample 503 perpendicularly to the incident light and scanning the monochromator 504 over the range of 0° to 90° (θm) while the sample 503 is rotated through 360° (φm) in a sample plane.

The constructions, the shapes, the materials, the numerical values, etc. explained in the foregoing embodiments and EXAMPLE are merely mentioned for illustrative purpose, and different constructions, shapes, materials, numerical values, etc. can also be used.

Also, the constructions in the above-described embodiments can be selectively combined with each other without departing from the scope.

While the foregoing embodiments have been described, by way of example, in connection with the case where the blind device and the rolling screen device are manually operated, the blind device and the rolling screen device may be electrically operated.

While the foregoing embodiments have been described, by way of example, in connection with the case where the optical film is attached to the adherend, such as the window member, the adherend, such as the window member, may be constituted as the first optical layer or the second optical layer itself of the optical film. That modification can impart the directional reflection function to the adherend, such as the window member, in advance.

While the foregoing embodiments have been described, by way of example, in connection with the case of applying the present invention to the interior or exterior members, such as the window member, the fitting, the slat of the blind device, and the screen of the rolling screen device, application examples are not limited to the illustrated ones, and other interior and exterior members than the above-described ones are also included in application targets.

Examples of the interior or exterior members to which the optical body according to the embodiment is applicable include an interior or exterior member formed by the optical body itself, and an interior or exterior member formed by a transparent base element to which the directional reflector is attached. By installing such an interior or exterior member indoors near a window, it is possible to directionally reflect only, e.g., an infrared ray to the outdoor, and to take, e.g., visible light, into the indoor. Accordingly, even when the interior or exterior member is installed, necessity of lighting in an indoor space is reduced. Further, since the interior or exterior member hardly causes scatter reflections toward the indoor side, a temperature rise in the surroundings can be suppressed. In addition, the optical body may be applied to other attachment target members (adherends) than the transparent base element depending on the desired purpose such as controlling visibility and/or increasing strength.

While the foregoing embodiments have been described, by way of example, in connection with the case of applying the embodiments to the blind device and the rolling screen device, application examples are not limited to the illustrated ones, and various solar shading devices installed indoors or outdoors are also included in application targets.

While the foregoing embodiments have been described, by way of example, in connection with the case of applying the embodiments to the solar shading device (e.g., the rolling screen device) where an extent at which the solar shading member shields the incident light can be adjusted by taking up or letting out the solar shading member, application examples are not limited to the illustrated one. For example, embodiments are applicable to a solar shading device where an extent at which a solar shading member shields the incident light can be adjusted by folding or unfolding the solar shading member. One example of such a solar shading device is a pleated screen device where an extent at which a solar shading member shields the incident light can be adjusted by folding or unfolding a screen as the solar shading member in the form of bellows.

While the foregoing embodiments have been described, by way of example, in connection with the case of applying the embodiments to a horizontal-type blind device (Venetian blind device), a vertical-type blind device can also be included in application targets.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical body comprising:
an optical layer having a belt-like or rectangular shape and having an incident surface on which light is incident; and
a reflective layer formed in the optical layer and having a corner cube shape,
wherein the reflective layer directionally reflects the light incident on the incident surface at an incident angle (θ, φ), and
a direction of a ridge of the corner cube shape is substantially parallel to a lengthwise direction of the belt-shaped or rectangular optical layer,
(θ being an angle formed by a perpendicular line with respect to the incident surface and the incident light incident on the incident surface or reflected light emerging from the incident surface, and φ being an angle formed by the ridge of the corner cube shape and a component resulting from projecting the incident light or the reflected light to the incident surface).

2. An optical body comprising:
an optical layer having a belt-like or rectangular shape and having an incident surface on which light is incident; and
a reflective layer formed on the incident surface of the optical layer and having a corner cube shape,
wherein the reflective layer directionally reflects the light incident on the incident surface at an incident angle (θ, φ), and
a direction of a ridge of the corner cube shape is substantially parallel to a lengthwise direction of the belt-shaped or rectangular optical layer,
(θ being an angle formed by a perpendicular line with respect to the incident surface and the incident light incident on the incident surface or reflected light emerging from the incident surface, and φ being an angle formed by the ridge of the corner cube shape and a component resulting from projecting the incident light or the reflected light to the incident surface).

3. The optical body according to claim 1, wherein the corner cube shape is formed such that the direction of the ridge of the corner cube shape is substantially parallel to a height direction of a building.

4. The optical body according to claim 1, wherein the reflective layer is a wavelength-selective reflective layer directionally reflecting, of the light incident on the incident surface at the incident angle (θ, φ), light in a specific wavelength band, but transmitting light in wavelength bands other than the specific wavelength band.

5. The optical body according to claim 1, wherein the directionally reflected light is a near infrared ray primarily in a wavelength band of 780 nm to 2100 nm.

6. The optical body according to claim 5, wherein the wavelength-selective reflective layer is a transparent conductive layer containing, as a main component, an electrically conductive material that has transparency in a visible range, or a functional layer containing, as a main component, a chromic material having reflection performance that is reversibly changed with an external stimulus.

7. The optical body according to claim 5, wherein a value of transmission image clarity measured using an optical comb of 0.5 mm in conformity with JIS K-7105 is 50 or larger for the light of transmission wavelengths.

8. The optical body according to claim 5, wherein a total of values of transmission image clarity measured using optical combs of 0.125 mm, 0.5 mm, 1.0 mm and 2.0 mm in conformity with JIS K-7105 is 230 or larger for the light of transmission wavelengths.

9. The optical body according to claim 1, wherein the corner cube shape is two-dimensionally arrayed in a close-packed state.

10. The optical body according to claim 1, wherein the optical layer and the reflective layer have flexibility and are capable of being wound into the form of a roll.

11. The optical body according to claim 1, wherein the light is incident on one of the incident surface and an emergent surface of the optical layer at the incident angle of 5° or larger and 60° or smaller, and each of an absolute value of difference between chromaticity coordinates x and an absolute value of difference between chromaticity coordinates y of specular reflection lights reflected by the optical layer and the reflective layer is 0.05 or smaller at each of the incident surfaces and the emergent surface.

12. A window member including the optical body according to claim 1.

13. A method of attaching an optical body comprising:
attaching a belt-shaped or rectangular optical body to a window member of a building such that a lengthwise direction of the optical body is substantially parallel to a height direction of the building,
the optical body comprising:
an optical layer having an incident surface on which light is incident; and
a reflective layer formed in the optical layer and having a corner cube shape,
wherein the reflective layer directionally reflects the light incident on the incident surface at an incident angle (θ, φ), and
a direction of a ridge of the corner cube shape is substantially parallel to the lengthwise direction of the belt-shaped or rectangular optical layer,
(θ being an angle formed by a perpendicular line with respect to the incident surface and the incident light incident on the incident surface or reflected light emerging from the incident surface, and φ being an angle formed by the ridge of the corner cube shape and a component resulting from projecting the incident light or the reflected light to the incident surface).

14. A method of manufacturing an optical body comprising:
forming a first optical layer having a concave-convex surface in which a plurality of structures having a corner cube shape are formed;
forming a reflective layer on the concave-convex surface of the first optical layer; and
forming a second optical layer on the reflective layer,
both of the first optical layer and the second optical layer forming an optical layer having a belt-like or rectangular shape and having an incident surface on which light is incident,
wherein the reflective layer directionally reflects the light incident on the incident surface at an incident angle (θ, φ), and
a direction of a ridge of the corner cube shape is substantially parallel to a lengthwise direction of the belt-shaped or rectangular optical layer,
(θ being an angle formed by a perpendicular line with respect to the incident surface and the incident light incident on the incident surface or reflected light emerging from the incident surface, and φ being an angle formed by the ridge of the corner cube shape and a component resulting from projecting the incident light or the reflected light to the incident surface).

15. The optical body manufacturing method according to claim 14, wherein, in forming the first optical layer, the belt-shaped or rectangular first optical layer having the concave-convex surface is formed by transferring a concave-convex shape of a roll-shaped master to a resin.
